(19) United States
(12) Patent Application Publication
(10) Pub. No.: US 2020/0193541 A1
(43) Pub. Date: Jun. 18, 2020

(54) COMPUTER SYSTEM ENABLING FLEXIBLE CREATION OF AND PARTICIPATION IN BLOCKCHAIN-BASED SMART CONTRACTS FOR TRANSACTIONS IN TOKENIZED DIGITAL ASSETS

(71) Applicant: Crosschain Group LLC, Franklin Park, NJ (US)

(72) Inventors: Robert Barry, Franklin Park, NJ (US); Douglas Molina, Heredia (CR); Carlos Cerrato, Heredia (CR)

(21) Appl. No.: 16/711,810

(22) Filed: Dec. 12, 2019

Related U.S. Application Data
(60) Provisional application No. 62/781,131, filed on Dec. 18, 2018.

(51) Int. Cl. G06Q 50/18; H04L 9/32

(52) U.S. Cl. CPC G06Q 50/18; H04L 9/32

(57) ABSTRACT

A computer system includes a blockchain platform having a distributed application deployed thereon. The distributed application includes storage for storing data for smart contracts on the blockchain platform. Smart contracts communicate with and store data in the storage. An upgradeable contract object is used with this storage. A smart contract has a plurality of states and an associated sponsor. The sponsor is primarily in control of changing the states of the contract with which it is associated. The smart contract has a reference to an address registry, also on the blockchain platform, which identifies authorized potential participants. These authorized potential participants for the smart contract can elect to participant in that smart contract. When a participant elects to participate in a smart contract, the address registry is checked to verify that an individual is an authorized potential participant. When an individual wants to register as a potential participant, the system accesses an oracle object that verifies the identity of the individual. If that identify is verified, the system adds the individual to the address registry. A suitable graphical user interface enables sponsors and participants to view and update information about the smart contracts with which they are associated.

### BACKGROUND

Computer implementations of a concept called a “distributed ledger”, also called a “blockchain”, have been demonstrated to be a reliable way of tracking and authenticating transactions with respect to digital objects. A blockchain platform is a computer platform that accesses multiple computers over a computer network which support the distributed ledger in maintaining digital objects.

A digital object on a blockchain platform is an identifiable object that specifies both executable code and data associated with the object. The digital object has an identifier on the blockchain platform which can be used to access that digital object on the blockchain platform and execute its corresponding executable code. The executable code enforces rules about how the data associated with the object can change. Such changes could represent, for example, changes in state, such as “ownership”, associated with the object. However, the original digital object is immutable. Any change to an object is represented by an additional object that defines the change by reference to the object being changed. The resulting chain of objects, in combination, represents the current state of the digital object. The distributed ledger tracks the changes that have been made to the object.

Such technologies have enabled so-called “smart contracts” to be created and used for a variety of applications. A smart contract is a digital object on a blockchain in which the executable code enforces a set of rules applicable to the digital object. In a simple case, such smart contracts can simply represent a digital token that can be exchanged among different entities. For more complex uses, the enforcement of rules allows a smart contract to support agreements between different parties, as these rules can be defined in accordance with the rules under which the parties have agreed to interact with each other. A smart contract can be used to allow an agreement to be automatically enforced according to a set of rules.

### SUMMARY

This Summary is provided to introduce a selection of concepts in a simplified form that are further described below in the Detailed Description. This Summary is intended neither to identify key or essential features, nor to limit the scope, of the claimed subject matter.

There are several obstacles to practical uses of smart contracts to support agreements.

First, implementations of blockchain are generally inefficient for accessing information about smart contracts secured by the blockchain. Inefficiencies arise because the current state of any digital object on the blockchain is determined by combining of all the referenced objects in the chain of objects which represents that digital object. While some blockchain platforms maintain a cache of this current state, not all operations on a digital object on a blockchain can rely on using cached state information.

In practice, any agreement generally results from a first entity, an offeror, making an offer, in response to which one or more second entities, offerees, may accept that offer, to establish the agreement. To apply a smart contract to automatically enforce such an agreement, the various terms need to be established as deterministic rules implemented by the smart contract. To provide an offeror flexibility, a platform supporting smart contracts should allow offerors to make offers available to selected offerees, in some cases at the offeror's discretion. The platform also should allow offerees the flexibility to identify and accept those offers in which they are interested. Such flexibility, when implemented using digital objects on a blockchain, introduces numerous complexities, at least because the original digital object representing any smart contract is immutable, and any changes to that object are represented as additional, referencing objects.

Parties to an agreement generally wish to know and confirm the identity of other parties to the agreement at the time the agreement is made. An offeror wants to confirm that the offeree's identity and ability to perform prior to making an offer that can be accepted. An offeree wants to confirm the offeror's identity and ability to perform prior to accepting an offer. Thus, a platform supporting smart contracts should support verification of the identity of each party prior to obligations being created among the parties. Also, the platform should ensure that parties to the agreement, and no one else, are able to make changes to the smart contract which enforces their agreement.

The following disclosure describes a computer system that implements solutions that address these and other problems faced in supporting practical uses of smart contracts to support agreements. Such smart contracts are called “deal smart contracts” herein. A computer system includes a blockchain platform having a distributed application deployed thereon. The distributed application includes storage for storing data for the deal smart contracts on the blockchain platform. Deal smart contracts communicate with and store data in the storage. An upgradeable smart contract object is used with this storage to represent a deal smart contract. A deal smart contract has a plurality of states and has an associated entity which is primarily in control of changing the states of the deal smart contract. This entity is referred to herein as a “sponsor” and generally is in the role of an offeror in the agreement enforced by the deal smart contract.

The deal smart contract has a reference to an address registry, also on the blockchain platform, which identifies authorized potential “participants” to the deal smart contract. These authorized potential participants for the deal smart contract generally are in the role of offerees of the agreement enforced by the deal smart contract. A participant can elect to participate in any deal smart contract for which the participant is authorized. When a participant elects to participate in a smart contract, the address registry is checked to verify that an individual is an authorized potential participant. When an individual wants to register as a potential participant, the system accesses an oracle object that verifies the identity of the individual. If that identify is verified, the system adds the individual to the address registry. The use of such an address registry and oracle object enables the computer system to avoid storing private keys for users for performing transactions on the blockchain platform.

The computer system also includes a host platform which provides a graphical user interface which enables sponsors to easily create, view and update deal smart contracts, and participants to view, participate in and update information about the deal smart contracts. The host platform provides information about deal smart contracts to client computers, and enables users using those client computers to perform actions with respect to deal smart contracts on the blockchain platform and on the host platform.

The computer system also automates handling of transaction terms, such as distributions to the sponsors and participants. The system also pre-configures blockchain transaction signing.

The system also supports messaging among sponsors and participants within a host platform, separate from the blockchain platform, yet integrated with messaging about changes in the deal smart contracts in which they are active. Events occurring on the blockchain supporting a deal smart contract, and events occurring within the host platform for managing the deal smart contracts, are detected by the host platform. In response to these events, the host platform generates messages within each corresponding deal smart contract. Sponsors and participants of a deal smart contract also can generate messages on the host platform for the deal smart contract. These messages, both due to events and due to messages generated by users on the host platform, can be provided to the sponsors and participants in an integrated view within the host platform.

In the following description, reference is made to the accompanying drawings which form a part hereof, and in which are shown, by way of illustration, specific example implementations of this technique. It is understood that other embodiments may be utilized and structural changes may be made without departing from the scope of the disclosure.

### BRIEF DESCRIPTION OF THE DRAWINGS

FIG. 1 is a block diagram of an example computer system that supports smart contracts.

FIG. 2 is a use case diagram illustrating interactions of sponsors and participants with the computer system.

FIG. 3 is a use case diagram illustrating interactions of administrators with the computer system.

FIG. 4 is an entity diagram illustrating relationships among objects defined to implement smart contracts in an example implementation of the computer system.

FIG. 5 is a detailed diagram of an example implementation of DealContract, DealFactory and TokenTable object classes, including their data fields and methods, in an example implementation of the computer system.

FIG. 6 is a state transition diagram for an example implementation of the computer system.

FIG. 7 is a process diagram describing a process for creating a deal in an example implementation of the computer system.

FIG. 8 is a process diagram describing a process for registering a participant in an example implementation of the computer system.

FIG. 9 is a process diagram describing a process for a participant to contribute to a deal in an example implementation of the computer system.

FIG. 10 is a process diagram describing a process for locking a deal in an example implementation of the computer system.

FIG. 11 is a process diagram describing a process for cancelling a deal in an example implementation of the computer system.

FIG. 12 is a process diagram describing a process for withdrawing a token in an example implementation of the computer system.

FIG. 13 is a process diagram describing a process for pausing the computer system in an example implementation of the computer system.

FIGS. 14-25 are illustrative diagrams of data structures used by the system database.

FIGS. 26-35 are illustrative examples of graphical user interfaces for the system.

FIG. 36 is a block diagram of a general-purpose computer.

### DETAILED DESCRIPTION

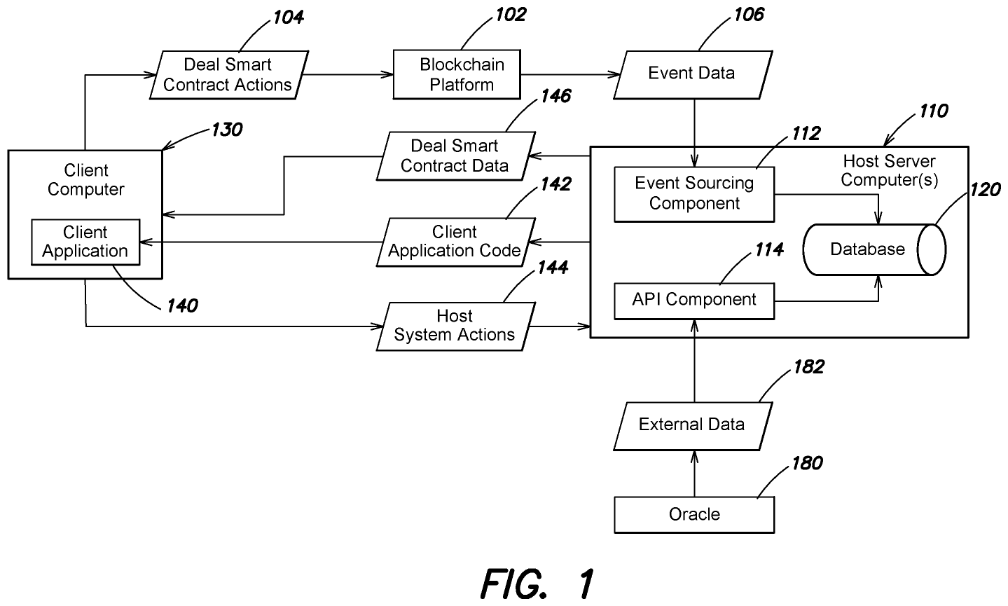

FIG. 1 is a block diagram of an example implementation of a computer system 100 that supports deal smart contracts using distributed ledger, or blockchain, technology. The block diagram provides a high-level component view of the system.

The computer system includes a blockchain-based platform 102, such as the ETHEREUM platform, on which a distributed application implementing blockchain-based deal smart contracts in accordance with the invention can be implemented, deployed, and supported. Such a platform has an interface through which actions can be taken with respect to deal smart contracts, as shown at 104. Such actions can include creating, participating in, locking, cancelling, closing, and performing emergency, security, and maintenance operations with respect to, deal smart contracts managed by the platform 102. Additionally, the platform 102 has an interface through which data 106 describing events related to deal smart contracts are provided. Such data generally includes data identifying a deal smart contract and an action taken with respect to that deal smart contract.

The computer system implements “upgradeable” smart contract objects as part of a distributed application deployed on the platform 102. Upgradeable smart contract objects are objects for which the executable code supporting them can change in order to address, for example, security issues discovered with the implementation of these objects. There are several known implementations of upgradeable smart contract objects. Such objects generally are made upgradeable by having the original digital object store a value that references the executable code for the digital object, allowing the referenced executable code to be changed.

A host server system 110 includes an event sourcing component 112 which receives and processes the event data 106 from the platform 102. In the implementation shown in FIG. 1, the platform 102 generates and sends event data 106 to the host server system 110. In other implementations, the host server system 110 can request the event data 106 from the platform 102, and the platform 102 can provide the event data 106 in response to a request. The event sourcing component 112 processes each event into data stored in a database 120, and optionally into notifications or other actions (not shown). The event sourcing component, in some implementations, can include separately executing processes for receiving event data, on the one hand, and processing the event data for storage and other actions, on the other hand.

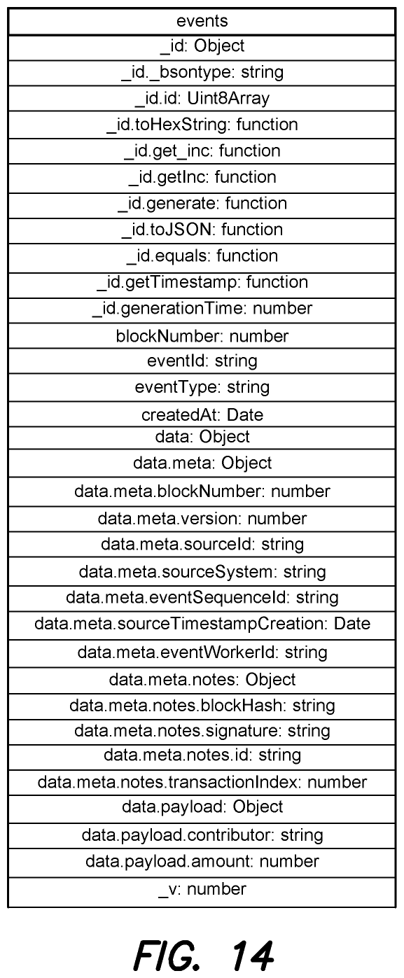

The host server system 110 includes an application programming interface (API) component 114 through which the database 120 is accessed. The database acts as a cache of the status of and information about the deal smart contracts managed by the platform 102, and other information used by the computer system 100 to provide its various functions. The database provides an efficient structure for reading this data by other components of the computer system 100. An example implementation of such a database 120 is described in more detail below in connection with FIGS. 14-25.

The application programming interface component 114 also allows components of the system to interact with an external data source 180. The external data source 180 is a source of external data 182 which may vary or fluctuate with high frequency, such as an exchange rate, or data which may be highly sensitive, such as authentication information of individuals which the platform will not store. The function of this interface is to allow the platform to bring in external data which is otherwise not compatible with the immutable nature of objects stored on the blockchain. In one implementation, the external data source can be an “oracle” such as the ORACLIZE blockchain oracle service or the CHAINLINK decentralized oracle network. In one implementation, the external data source provides an interface to a data source through which individuals can be authenticated and added to an address registry for the platform. Use of the oracle for this purpose also allows the platform not to store any private encryption keys which may be used for signing transactions on the blockchain.

In some implementations, the host server system 110 can include one or more computers, each of which provides a computing platform supported by an operating system for executing applications. An example operating system which can be used is the UBUNTU operating system. In some implementations, the event sourcing component 112 and the API component 114 can be applications implemented using JavaScript code executed on the NodeJS JavaScript run-time environment, running on top of the Meteorjs development environment. The event sourcing component can use the Web3.js library for interacting with the Ethereum platform. The database 120 can be implemented using, for example, a MongoDB database. In some implementations, the host server system 110 can include a separate servers for each of a web server (to provide an interface to the host server system for client computers, described below), an API server (to execute and support the API component 114, through which the web server accesses the database), an event sourcing server (to execute and support the event sourcing component 112), and a database server (to execute and support the database 120). These servers may be separate physical server machines or separate virtual machines executed on one or more server computers.

A plurality of client computers 130 allow end users to interact with the system. There generally are three categories of users: administrators that manage the computer system 100, sponsors who offer deals, supported by deal smart contracts, using the computer system 100, and participants who participate in the deals offered on the computer system 100. Each of these end users generally interacts with the computer system 100 through a respective client computer 130. An administrator may have direct access on the host server computer 110. Multiple end users may share a client computer 130. An end user may use multiple client computers 130.

A client computer 130 generally provides a platform that executes a client application 140, which is a computer program that, when executed by this platform, provides various functions to the end user for using the computer system 100. Example implementations of the client application 140 for different types of end users and different functions will be described in more detail below.

In some implementations, a client computer 130 may provide this platform through a JavaScript client, i.e., an application that can receive and execute computer programs written in the JavaScript programming language, such as a browser application. The JavaScript client includes additional functionality enabling the client computer to access and perform actions 144 with the host server system 110, and to access and perform actions 104 with the blockchain platform 102. In some implementations, the browser application is the Chrome browser application which has been augmented with plug-ins implementing the Web3.js library and the React.js library. In this implementation, the client application 140 can be implemented using JavaScript code, hypertext markup language (HTML) code, and (CSS) code, with dependencies on the Web3.js and Meteor.js libraries to access the Ethereum platform and the host server computer respectively, and on the React.js libraries to provide visual components presented by the client application 140 to the end user. Generally speaking, when an end user directs the browser application to access the host server system 110, the host server system sends client application code 142 to the client computer 130, which the browser application executes to provide the client application 140.

The client computers 130, host server system 110, and platform 102 forming the computer system 100 are interconnected by one or more computer networks, which may include a combination of private and public computer networks.

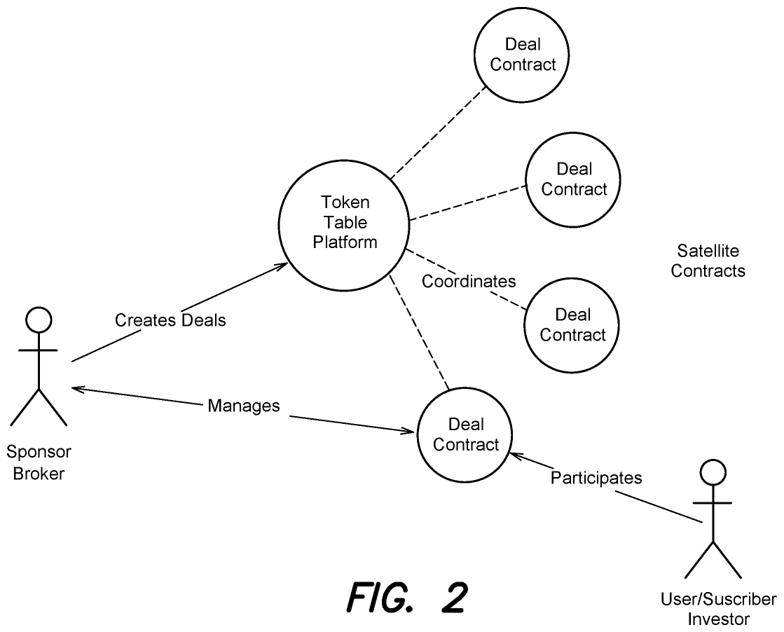

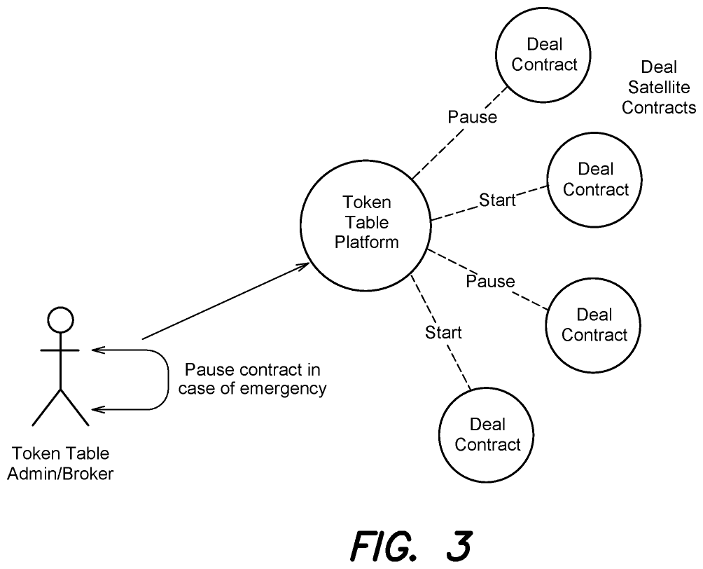

Turning now to FIGS. 2 and 3, a high-level overview of some of the end user operations supported by the computer system 100 will now be described. In general, the client application 140 receives information 146 from the host server computer 110 about deal smart contracts supported on the blockchain platform 102. The client application 140 then enables a user to perform various actions with respect to those deals, whether through visualization or manipulation of information to or from the host server computer 110, or by performing action 104 on deal smart contracts on the blockchain platform 102.

In FIG. 2, “sponsor” end users are those entities that create deals, i.e., make offers, using the computer system 100 to manage and secure those deals as deal smart contracts. Generally speaking, the sponsor defines the terms of a deal, and the conditions for others to participate in the deal, and those terms and participants are associated with a deal smart contract by the computer system 100. The sponsor may be a broker for another entity. The computer system 100 then secures, and coordinates all further transactions with respect to, the deal smart contract.

A “participant” end user (also called an “investor” or “subscriber”) is an entity that can participate in a deal offered as a deal smart contract secured and coordinated by the computer system 100.

An “administrator” end user manages the computer system 100 as shown in FIG. 3. As an example managerial operation, an administrator can “pause” a deal smart contract, suspending all further transactions in connection with the deal smart contract, and then restart the deal smart contract. A deal smart contract may be paused and restarted to allow the executable code for the deal smart contract to be upgraded after the deal smart contract has been deployed.

Given such a computer system, there are several features which allow a sponsor to offer deals, secured as deal smart contracts, to participants through this computer system in way that addresses the problems noted above. In particular, the computer system provides sponsors flexibility in offering deals to select participants, verifies the identity of each participant, and provides efficient access to information about the deal smart contracts supported by the computer system. The remainder of this Detailed Description provides an example implementation of the computer system 100 that supports these and other features.

To provide some context, this computer system can support the following use case. A sponsor creates a “deal” on the platform, such as a deal through which participants will receive a token representing a share of, or example, a pool of real estate income and proceeds, in exchange for other tokens having value on the Ethereum platform, typically a form of digital coin. Potential participants are informed of the deal. The potential participants may be approved for participation either before or after they are informed of the deal. The platform ensures that a potential participant is approved before authorizing participation. When an approved entity elects to participate, the platform accepts their participation and collects their tokens. After other conditions are met to complete the deal, the platform allows the tokens representing the respective shares to be distributed to the participants and tokens collected from the participants to be distributed to the sponsor and the owner of the platform as a commission.

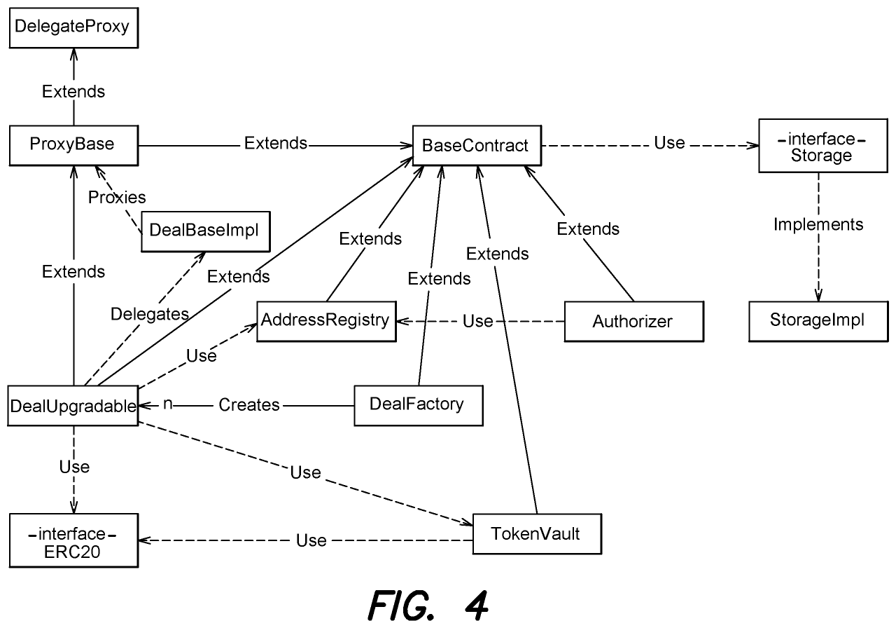

An overview of the data model and state models for deal smart contracts will now be described in connection with FIGS. 4 through 6.

Referring to FIG. 4, an entity diagram describing a data model for an example implementation of deal smart contracts on this computer system will now be described. An example implementation of a data model for the internal database used by the computer system is described in more detail below in connection with FIGS. 14-25. In this example implementation of deal smart contracts, most object classes in the data model are based on a core, base object class (labeled “BaseContract”) which is a smart contract object. In other words, other object classes in the data model extend a base smart contract object class, inheriting its properties, thus all objects can be deployed on a blockchain platform, such as the Ethereum platform.

The base contract object class uses an interface to exchange data with a storage object (labeled “StorageImpl”), which is also an object on the blockchain platform. A storage object provides separate, secure data storage for upgradeable objects on the blockchain. In other words, any base contract object on the platform stores its data in the storage object. As a result, if the implementation of a contract object class is upgraded, data associated with instances of that contract object are not lost. Generally speaking, the storage object can store data for all objects in the computer system as key-value pairs. The storage object also enforces access control to any manipulations applied to the stored data.

One of the objects that extends the Base Contract object is an upgradeable deal smart contract object (labeled “DealUpgradeable”). Such upgrades may occur, for example, for security reasons.

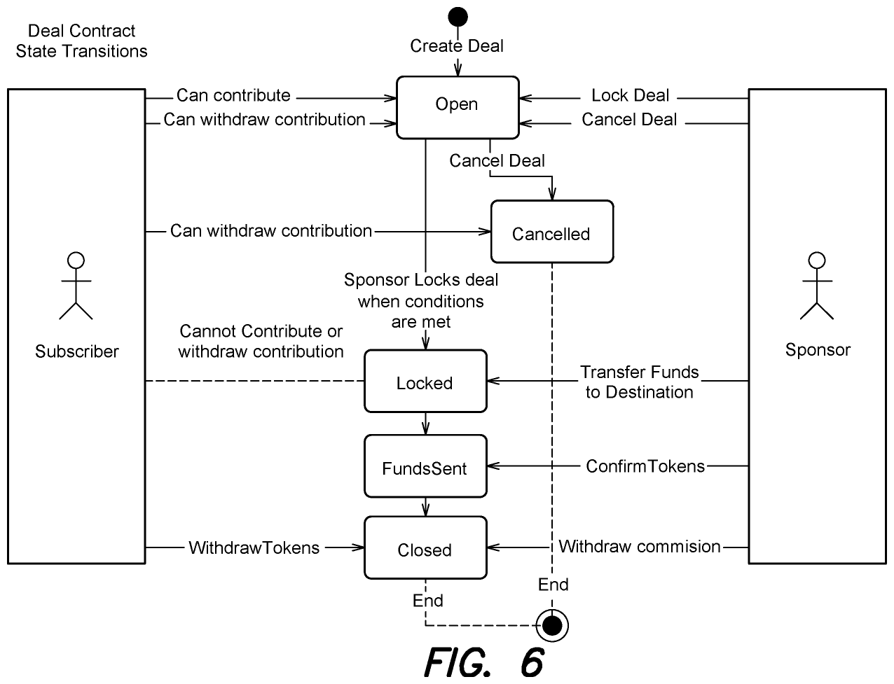

The deal smart contract object controls the primary logic of smart contracts that enforces deals from the perspective of both sponsors and participants. It implements the functionality for the core operations of managing a deal and contributing to a deal. For example, this object allows: participants to participate in the deal; sponsors to lock or cancel the deal depending of the conditions established by the sponsor; participants to withdraw any contributions made after the deal has been cancelled or the deal has not been locked by the sponsor; participants to claim their proceeds from the deal when availability of the proceeds are confirmed by the sponsor; and sponsors to withdraw their own proceeds from the deal when available. Access to these functions are limited to the sponsor and affect the state of the deal contract object. This design ensures that platform's administrators generally do not have any specific access to execute the managing functions of a deal smart contract object, such as Lock/Cancel/Transfer Funds to Vendor, etc. Administrator users may have access to execute fail-safe mechanisms, such as where the smart contract enforcing a deal is in a locked state and distributions have not been made for a set period of time. The possible deal states for this implementation are described in more detail below in connection with FIG. 6.

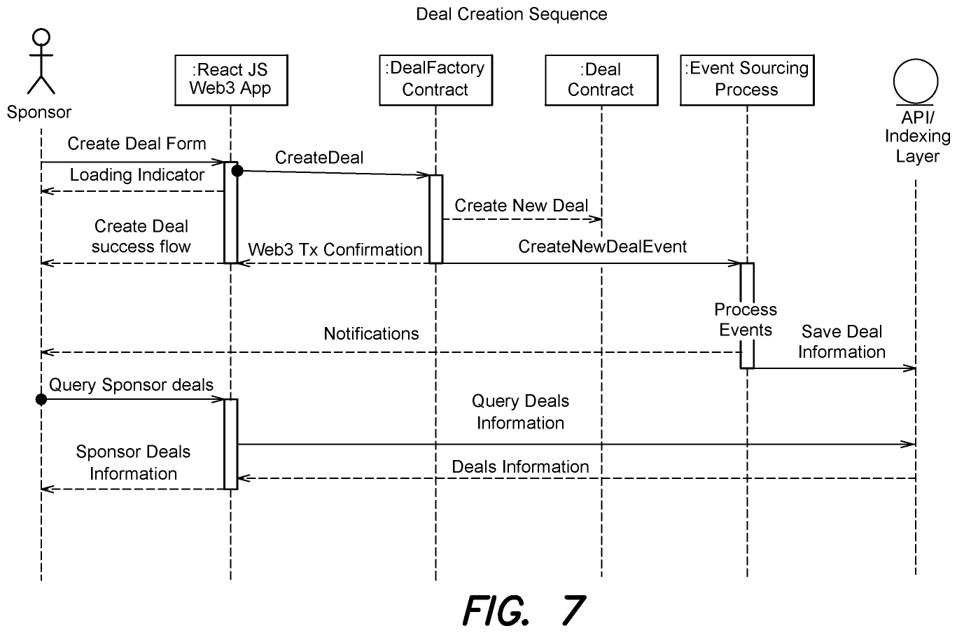

The primary use case for an instance of a deal smart contract is the following. After creation of the deal contract object, the initial state of the deal smart contract is “Open”. In this state, participants can send tokens to the deal smart contract through the end user's interface to this computer system. The deal smart contract keeps track of the participants' addresses and contributions in a mapping for convenient access and storage. After a goal (such as number of participants or amount contributed) is reached the sponsor may lock the deal to disallow access by participants to further contribute to or to withdraw from participation in the deal. After the state of the deal smart contract is set to “locked”, the sponsor can send the sponsor's balance of tokens for the deal smart contract to a specified entity or destination, for which an address was saved when creating the deal smart contract. The sponsor also can confirm the participants' tokens are transferred to the deal smart contract. The sponsor can withdraw tokens received from the participants according to rules established by the deal smart contract. Similarly, participants can withdraw tokens from the deal smart contract according to distribution rules established for the deal smart contract. The deal smart contract keeps track of each payed participant and updates the information in state information of the deal smart contract. In some implementations, the deal smart contract can be configured such that each participant withdraws all tokens in one transaction and is not able to withdraw less than or more than the entire token balance. More details of an example implementation of these state transitions are described below in connection with FIGS. 7-12.

Returning to FIG. 4, a deal factory object (“DealFactory”) is an extension of the base smart contract object which can be used to create new instances of a deal smart contract object.

An address registry object (“AddressRegistry”) is an extension of the base smart contract object which can be used to track information identifying, and verifying the identify of, participants in deals coordinated by this computer system.

An authorizer object (“Authorizer”) is an extension of the base smart contract object which can be used to determine whether a given entity is authorized as a participant in deals coordinated by this computer system, based on information it accesses from an address registry instance.

A token vault object (“TokenVault”) is an extension of the base smart contract object which stores information describing token distribution balance for tokens for a given deal smart contract instance, where each token is a portion of the deal associated with that deal smart contract instance. The owner of the token vault instance is the deal smart contract instance that uses it, and controls its withdrawal logic. The purpose of this object is to store tokens from distributions for a deal smart contract in a secure and safe way. This object is created by the deal smart contract to store the tokens distributed to the deal smart contract, which are then withdrawn by participants. Participants should be able to withdraw their credited tokens from several distributions without worrying about the details of each distribution amount. In this implementation, the token vault object does not need to be an upgradable object since it does not handle any major logic and functions as a store for the token balances of each distribution. In some implementations, the token vault can be compatible with the ERC20 token standard to have compatibility with existing tokens, such as shown by an interface to an “ERC20” object. The main use cases of the token vault object are controlled by its deal smart contract instance, which creates a new instance of a token vault and tracks its address. The deal smart contract instance becomes the only owner of the newly created token vault instance, enabling the deal smart contract object to control the functions of the token vault.

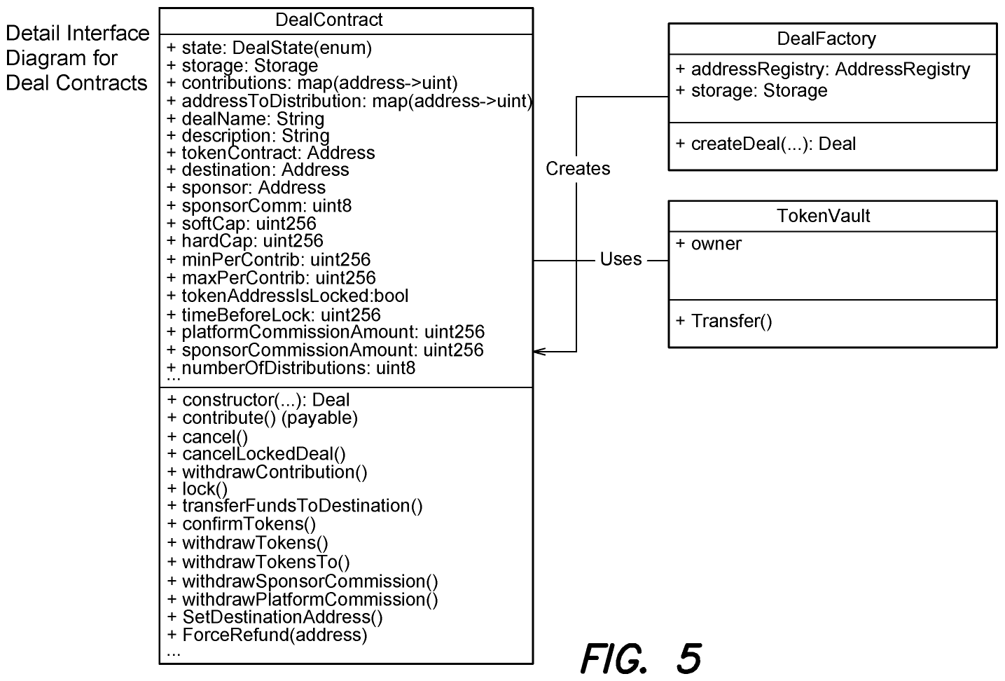

Referring to FIG. 5, a summary description of the deal smart contract, token vault and deal factory object classes will now be provided. More details about the data fields and methods used by these objects are provided below.

The deal factory object has two data fields: an indicator of an address registry, which refers to an address registry instance, and an indicator of a storage object that will store data about the deal smart contract to be created. The deal factory object has one method for creating a new instance of a deal smart contract object as a new deal smart contract, and an associated token vault instance, which is owned by the created deal smart contract instance. When the deal factory object creates the instances of the deal smart contract object, it associates the address of the deal smart contract on the blockchain with the address of its address registry on the blockchain in the storage object.

The token vault object has a data field indicating its owner, which is a reference to the deal smart contract instance co-created with it. Ownership of each vault is respective to a specific deal. The vault has one method for sending tokens to another smart contract or private wallet on the blockchain. This function allows to transfer a specific amount of tokens from an ERC20 object to another address on the blockchain platform which corresponds to another object on the blockchain platform, such as a private wallet. This method is used by the deal smart contract to distribute payment in tokens to its participants.

The deal smart contract object has several data fields used to represent a deal smart contract. There are several variations available for representing deal smart contracts and this representation is only intended to be an example. Most of the parameters of a deal smart contract can be set by the sponsor for the deal at the time the deal smart contract is created.

To allow a deal smart contract to be created and placed on a blockchain as an immutable object, yet allow for new participants to be added to the deal after the creation of the deal smart contract, the deal smart contract object is associated with an address registry object that can be updated. The technique for providing a deal smart contract object with an updateable address registry is similar to the technique used to allow the deal smart contract object to have upgradeable executable code, except the address registry is also an object on the blockchain. When a deal smart contract object needs to access its address registry object, it queries the platform's global storage, which returns the address of the address registry object. Then, the deal smart contract object can access its address registry object with the returned address. An address for the address registry object currently associated with the deal smart object is stored in the platform's global storage. When the address registry object is updated, the address for the updated address registry object is updated in the storage.

FIG. 5 also lists various methods associated with deal smart contract objects. Specifications for these methods are provided in further detail in Appendix I. Generally speaking, each method is used in connection with a transaction with respect to the deal smart contract. Such transactions related to the deal logic and deal states which will now be described in further detail.

Referring to FIG. 6, an example implementation of possible states that can be defined for a deal, i.e., the states in which a deal can exist, and transitions among them, will now be described. It should be understood that other implementations, including some with fewer or more states, and/or with different, fewer or more transitions, can be used. Any registered authorized sponsor of the computer system can create one or more deals and invite other users to participate and contribute to each deal it creates. The actions that can occur in different states, and which can cause transitions among the states, are described below from the perspective of actions performed by the participant or sponsor. The computer system acts in response to the actions taken by the participant or sponsor to effect the changes in state represented in FIG. 6.

In this example, after a sponsor creates a deal, the state of its deal smart contract is “open”, meaning that participants can now chose to participate in the deal. While the deal is open, any registered participant that has been invited by the sponsor join the deal can contribute to, or participate in, the deal. If a participant has contributed to or participated in deal, and the deal is still open, then the participant can withdraw that contribution or participation.

The sponsor of the deal, while the deal is still “open”, can cancel the deal. If the sponsor cancels the deal, then the deal smart contract transitions to a “cancelled” state. If the deal is cancelled, then any participant who has contributed to or participated in that deal can withdraw that contribution or participation. After any contributions have been withdrawn, the deal smart object transitions to a “fulfilled” state.

When a deal is “open” and conditions for the deal have been met, such as a minimum number of participants, then the sponsor can lock the deal. If the sponsor locks the deal, then the deal smart object transitions to a “locked” state. After a deal is locked, a participant can no longer withdraw its contribution or participation.

After the deal is locked, performance according to the deal begins. In most cases, the performance of a deal involves a transfer of funds represented by tokens in the form of digital coin on the blockchain platform. The participants or participants will ultimately receive their respective distributions of tokens resulting from performance of the deal. There may be other actions taken by entities as part of the performance of the deal.

When performance according to the deal has been completed, such as by the transfer of tokens by the sponsor to a destination, the deal smart contract transitions to a “FundsSent” state. This state can be understood as the deal being completed, where the sponsor is now able to verify that performance according to the deal has been completed. For example, if the funds to be distributed resulting from performance of the deal are represented by tokens to be withdrawn by the participants, the sponsor may confirm that these tokens are valid and can be distributed. After such confirmation, the deal smart contract can transition to a “closed” state.

When the deal has closed, the participants and sponsor can withdraw their respective tokens and commissions. After all tokens and commissions have been withdrawn, the closed deal ends, and the deal smart contract can transition to an “ended” state.

Turning now to FIGS. 14-25, an example implementation of the database 120 used by the platform 102 will now be described. In this example implementation, the database stores data representing several different entities such as events, users, deals, and other information. In an implementation using a no-SQL database such as MongoDB, these data structures can be stored as documents containing a set of pairs of field names and corresponding values, where each field name and a corresponding value are stored in the form of a respective key-value pair. For example, a user can be represented as a document containing a set of key-value pairs. All users can be represented as a collection of such documents. In yet other implementations, a relational database can be used, in which the collection of documents is equivalently represented as a table of records, with each row representing a user and each column corresponding to one of the field names, and each cell in a row storing a value corresponding to the field name of the respective column. Similarly, an object-oriented database also can be used.

FIG. 14 illustrates an example data structure for storing information about an event. Each event has at least an identifier and a type. A time stamp indicating when the event occurred and other data for the event also is stored. Such event data originates from the event listener, which monitors the blockchain for events related to a deal smart contract. Thus, the data stored for an event is dependent on the implementation of the event listener and the data provided by the event listener.

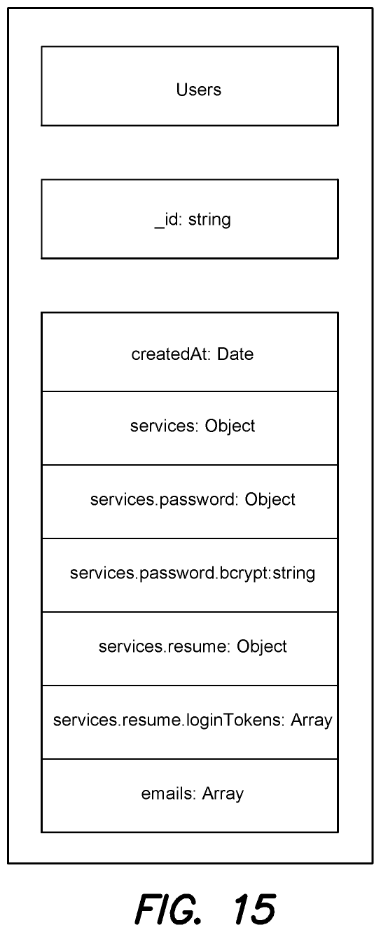

FIG. 15 illustrates an example data structure for storing system information about a user. Each user has at least a respective identifier within the system and a respective system information data structure. Other information about the user can include contact information, such as an email address, a date for when the user joined the system or was last updated, and information indicating the services of the system for which the user is authorized. Passwords for the user within the system also can be stored.

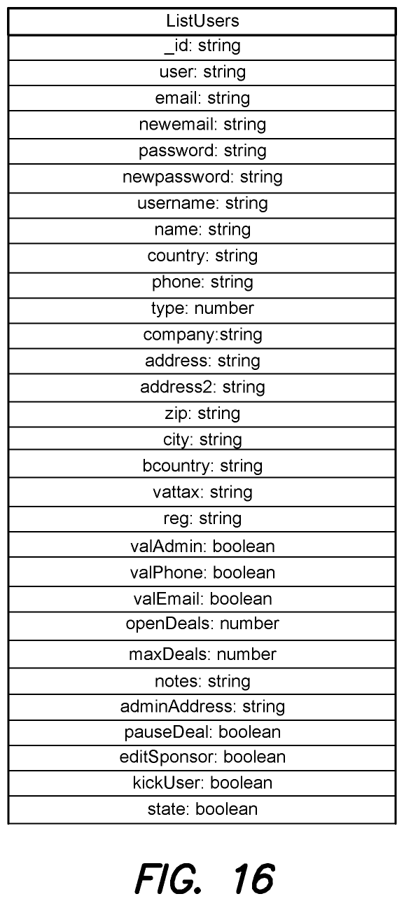

FIG. 16 illustrates an example data structure for storing user information about a user. Each user in the system has a respective user information data structure. Each user information data structure stores the respective identifier for that user. The identifier for the user stored in the user information data structure is the same identifier as stored in the respective system information data structure for that user. This data structure stores, for a user, respective data for that user including, but not limited to, detailed and validated contact information, and information about the open deals with which the user is associated, a maximum number of deals in which the user can participate. State information about the user, such as whether the user is a participant, sponsor, administrator, active, or inactive, also can be stored. If the user is a sponsor, data can be stored to indicate whether the user can pause a deal, edit a deal, and kick a user out of a deal. In a no-SQL database such a data structure is stored for each user as a list of key-value pairs in a document, and the documents for all users form a collection.

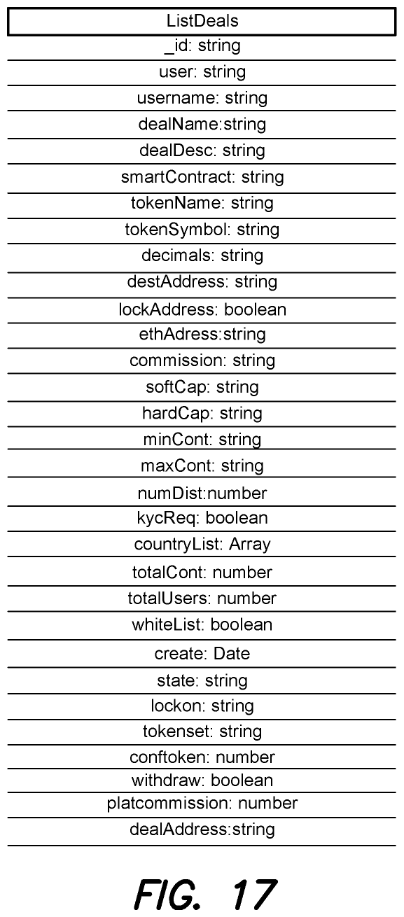

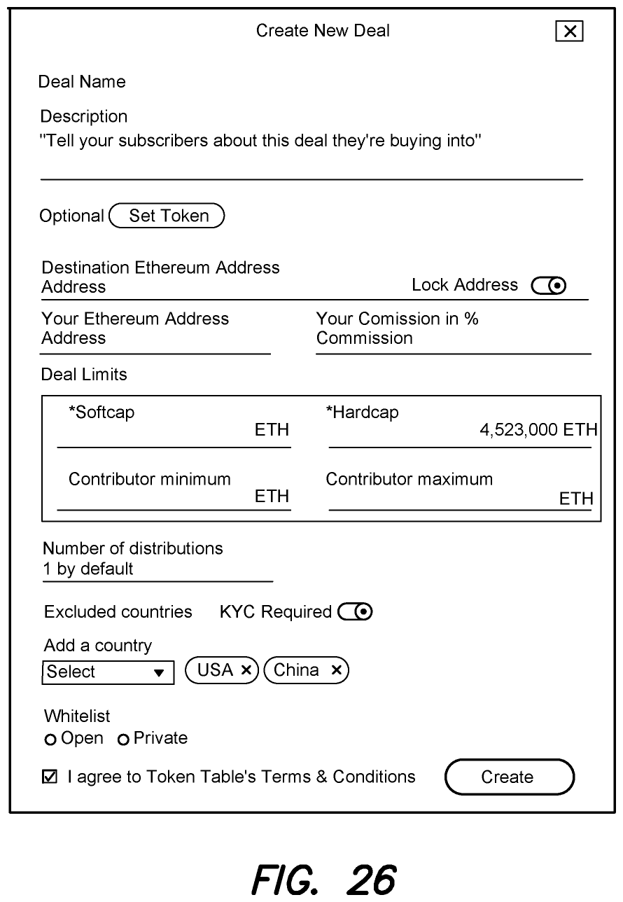

FIG. 17 illustrates an example data structure for storing information about a deal. The data structure stores, for a given deal, various information that identifies the deal, describes the deal, identifies the deal smart contract objects on the blockchain which support the deal, and stores other data about the state and history of the deal. In a no-SQL database, such a data structure can be stored for each deal as a list of key-value pairs in a document; the documents representing all deals form a collection. This information can be obtained from the sponsor through a graphical user interface (see FIG. 26) when a deal is created, and matches the data structure used to represent the corresponding deal smart contract object (see FIG. 5) created on the blockchain platform.

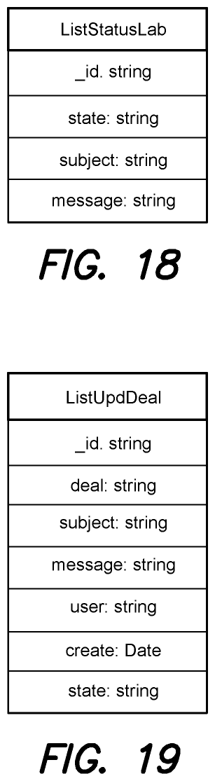

FIG. 18 illustrates an example data structure for storing information for a status message. Each data structure of this type stores data that forms a message within the messaging system of the platform. Each message corresponds to an event that can occur in the platform with respect to a deal smart contract. In response to an event occurring with respect to a deal smart contract, the status message data structure corresponding to that event is identified, and a message is generated for the deal using the identified status message data structure. The system has a collection of such status messages for various kinds of events. In this example, the status message data structure includes an identifier of the status message record, a state identifying a kind of event to which the status message corresponds, and a subject and message field providing text for a message to be generated if an event of that type occurs.

FIG. 19 illustrates an example data structure for storing information about the update messages generated for a deal. Each data structure can be stored as a document including a list of key-value pairs representing a message. Such messages can be generated in response to events emanating from the blockchain platform and in response to users posting messages with respect to a deal. A collection of such documents for a deal represents the messages generated for that deal. In this example, the data structure can include, for a given message, an identifier of the message, a reference to the deal smart contract, and information describing the message, such as a message subject, message body, users to whom or from whom the message was sent or was received, a message creation date, and state information. In a user interface, the collection of messages for a given deal can be processed to sort the messages and present graphical or other representations of the messages based on the data stored in these data structures.

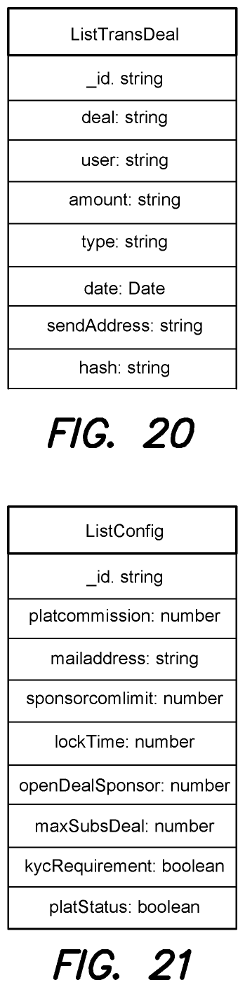

FIG. 20 illustrates an example data structure for storing information about a transaction that has occurred for a given deal. This data structure has an identifier for the transaction, a reference to a deal, and a reference to a user. A transaction generally involves an amount, such as a number of tokens, a type for the transaction such as a contribution or withdrawal, a date and time, and a destination address on the blockchain to which the tokens are to be sent. A hash value is the hash value of the transaction which is available from the blockchain, through a received event, after the transaction has committed. The state of the hash value is a default value (e.g., 0) indicating the transaction is pending, until the event indicating completion of the transaction is received, at which time this hash value is updated to be the value provided by the blockchain platform.

FIG. 21 illustrates an example data structure for storing configuration information for the platform. This configuration information specifies values for parameters that are used to configure deals and users on the platform. There is one instance of this data structure for the deal smart contract platform. This data structure can include, for example, an identifier for the data structure. A commission for the platform provider, which is a percentage taken from deal proceeds, can be stored. A maximum amount of time for a deal to be transitioned to a locked state can be stored. A number of open deals any sponsor may have, a maximum number of subscribers per deal, and any “know-your-customer” or authentication requirement for deals can be stored. A status field can indicate whether deals on the platform are paused or not.

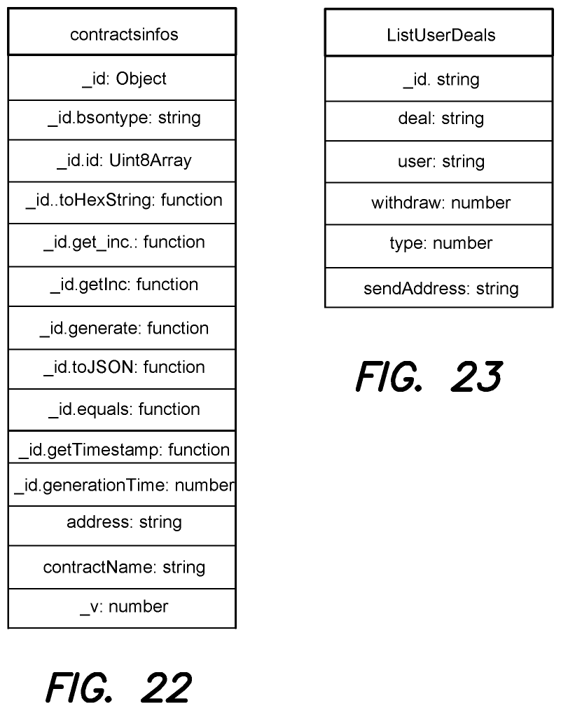

FIG. 22 illustrates an example data structure for storing information about a deal smart contract on the blockchain-based platform. In particular, each data structure stores, for a given deal smart contract, an address on the blockchain for that smart contract, and a name for the deal. A version number indicating a version of the deal smart contract implementation that supports the deal also may be stored. Various other information about the deal smart contracts can be stored. The platform stores a collection of such data structures, one for each deal smart contract.

FIG. 23 illustrates an example data structure for storing information that associates deals with users that are participants in those deals. This data structure, for each association, has an identifier, and includes data referencing a respective deal and a respective user associated with that deal. A withdrawal amount and type are also tracked, along with an address to which to send the withdrawal amount to the user.

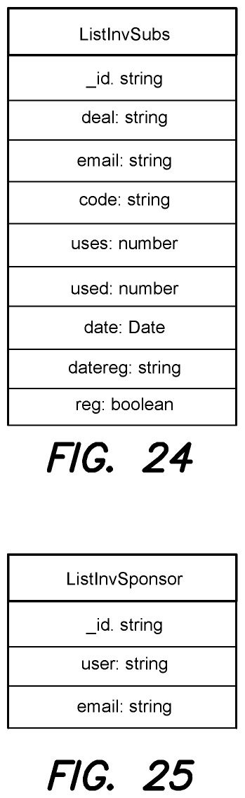

FIG. 24 illustrates an example data structure for storing information about invitations sent to potential subscribers (participants). Each invitation sent has a corresponding data structure which includes an identifier of that data structure, a reference to the deal, and an email address of the invited subscriber. This data structure also tracks the state of the invitation, indicating whether the invitation has been accepted or used, the date of sending the invitation, the date the invitation was accepted (if any), and a value indicating whether the invitation was accepted.

FIG. 25 illustrates an example data structure for storing contact information for users who have been invited to be sponsors on the platform. For each invitation sent to a user, offering that user sponsor status, has a corresponding data structure which includes an identifier of the data structure, a reference to a user object (see FIG. 16) for the respective invitee, and an email address of the invitee. Other information can be stored about such invitations.

Turning now to FIGS. 7-13, further details of an example implementation of operations performed by the computer system to implement deal smart contracts and transitions of deal smart contracts through their various states will now be described. The following description is based on the implementation of the computer system as described above in connection with FIGS. 1-6, which includes the implementation of several object classes, and the database that manages event tracking and other user information management, as described in FIGS. 14-25. Specifications for example implementations of the methods for the deal smart contract object, which are invoked in the processes described below, are described in more detail in the attached Appendix I.

FIG. 7 illustrates an example implementation of a deal creation sequence. This sequence of operations presumes that a registered sponsor has been authenticated and authorized to use the computer system.

The application executed by the sponsor's client computer presents to the sponsor, through a graphical user interface of, an interface allowing the sponsor to select and input various data defining the deal (See FIG. 26). The sponsor submits the completed form for creating the deal to the application. In response the application invokes a “create deal” method of a deal factory object. The deal factory object, in turn, creates a new instance of a deal contract object (see FIG. 5), and transmits a confirmation back to the application indicating whether the action was successful. The application can convey appropriate information to the sponsor user about the status and outcome of the attempt to create a new contract through its graphical user interface. When the new deal contract instance is created, a “create new deal” event is generated by the platform, which is captured and processed by the event sourcing process. The event sourcing process saves information about the newly created deal in the database (see FIG. 17) through the API/indexing layer. The events captured by the event sourcing process also can be used to trigger notifications to the sponsor about the successful creation of the new deal contract object.

After deals have been created by a sponsor, the sponsor also may, through the graphical user interface of the application, query the system to view information about their deals. The application submits queries to the database through the API/indexing layer, and receives results from this database, which are in turn processed into display data to be presented to the sponsor.

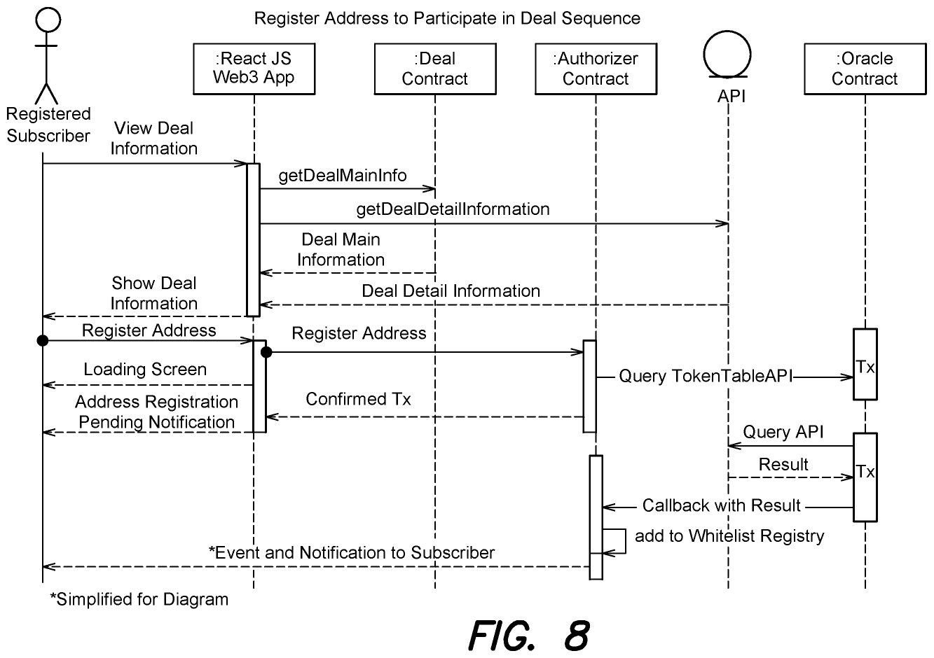

Turning now to FIG. 8, the registration of potential participant users (participants or participants) will now be described. This process allows the system to permit candidate participants to be added to a list of authorized participants for a deal after the deal is created, which in turn also allows authenticated participants to participate in a deal after the deal is created.

This process assumes that a “registered participant” is a participant that has registered with the system and is authorized to access and use the system to participate in deals. The registered participant, when accessing the system, using any of a variety of techniques provides an indication of a selected deal to the application. The application invokes the “getDealMainInfo” method of the deal contract object for the indicated deal, and invokes the getDealDetailInformation for that contract from the database through its API on the server. Given the retrieved deal information, the application generates display data for its graphical user interface to convey the deal information to the participant.

The participant then can request to be registered to participate in the selected deal, by submitting such a request through the application. The application invokes a “RegisterAddress” method of an authorizer object. Each participant requests the authorizer for authorization/registration for each deal that the participant wants to contribute to. The authorizer object handles the address registration/authorization process concerns by interacting with an oracle object. This interaction involves two transactions. The authorizer object initiates a query with the oracle object. The authorizer object provides an initial confirmation of this query to the application, indicating that a request for authorization has been submitted, but is pending confirmation. The application can convey this pending status to the participant. A second transaction resolves the user authorization to participate in the deal. The oracle object submits a query to authenticate the participant. After receiving a result of the authentication, the oracle object calls back the authorizer object with the result; the authorizer resolves whether the participant can be added or not to the address registry object corresponding to the deal contract object representing the deal. After the participant is added to the address registry object for the deal, the system recognizes the participant as authorized to participate in the deal if the participant so wishes. The addition of the participant to the address registry, or rejection of the participant's attempt to register, can be an event for the deal contract object that can be processed by the event sourcing process, thus updating the database. Such updates can result in notifications, e.g., to the participant and/or other users of the system.

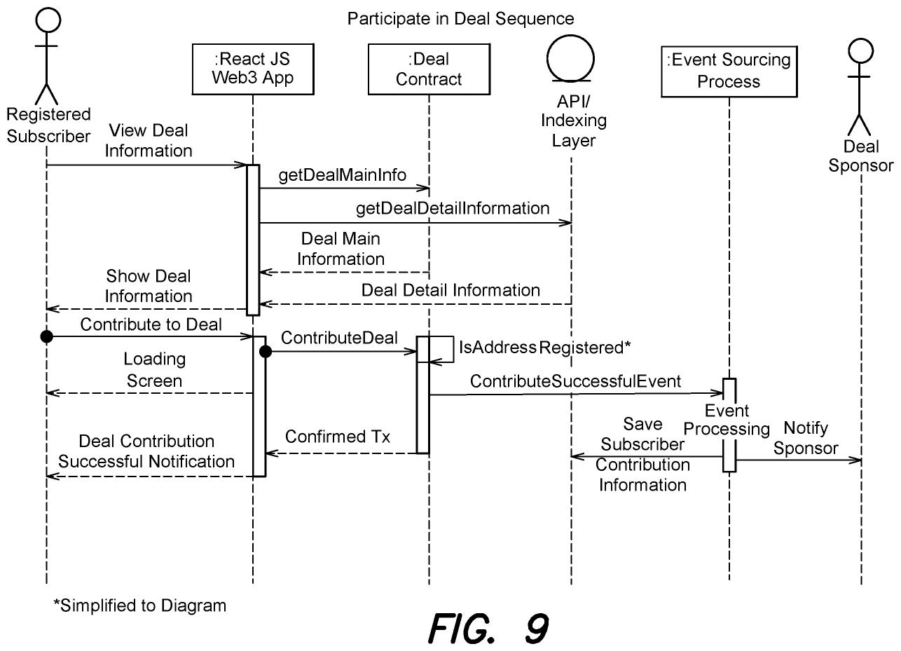

Turning now to FIG. 9, how a registered participant who has been registered for a specific deal can participate in that deal will now be described.

The registered participant, when accessing the system using any of a variety of techniques, provides an indication of a selected deal to the application. The application invokes the “getDealMainInfo” method of the deal contract object for the indicated deal, and invokes the getDealDetailInformation method for that contract from the database through its API on the server. Given the retrieved deal information, the application generates display data for its graphical user interface to convey the deal information to the participant. The participant then can request to contribute in the selected deal, by submitting such a request through the application. The application invokes a “ContributeDeal” method of the deal contract object. The deal contract object determines if the participant is in its address registry. If the participant is not in the deal's address registry, then the deal contract object can inform the application that the participant is not authorized to contribute to the deal. Otherwise, the deal contract object generates an event indicating that a contribution has been successfully processed. This event is processed by the event sourcing component, which updates the database and can generate a notification to be communicated to the sponsor. The deal contract object also communicates to the application that the participant's contribution has been successfully processed. In turn, the application communicates this status to the participant.

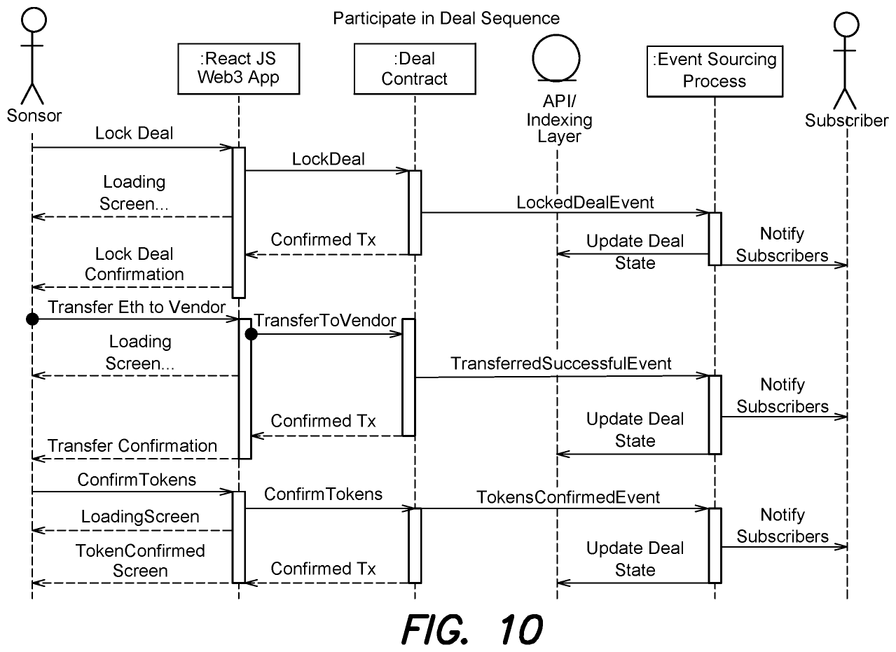

Turning now to FIG. 10, a process of locking a deal will now be described. In general, a deal typically has conditions, such as a minimum number of participants, which control whether a deal can be locked. A deal also may have a minimum amount of time or other condition to be met before a deal can be locked. Whether a deal can be locked generally is initiated by the deal sponsor, but can be set up so that the computer system locks the deal automatically upon satisfaction of certain conditions.

The process in FIG. 10 starts from a point where the application has presented to a sponsor user, through its graphical user interface, deal information for one of the sponsor's deals. The sponsor can request to lock a selected deal, by submitting such a request through the application. The sponsor can specify a time at which the deal will be locked, which can be immediately or several days later. When the lock is initiated, participants can no longer withdraw contributions. When the deal is fully locked, participants can no longer contribute, and cannot withdraw tokens until the deal is fulfilled. The application invokes the “LockDeal” method of the deal contract instance representing the selected deal. The deal contract object responds to the application confirming the status of the transaction, which the application in turn communicates to the sponsor. Locking the deal causes the system to generate a “locked deal” event, which the event sourcing component captures and processes. The deal state is updated in the database, and participants to the deal can be notified.

After a deal is locked, in one implementation in this state, participants no longer have control direct over their contributed tokens or the ability to contribute further, and the sponsor no longer has the ability to withdraw or cancel the deal. Also, after a deal is locked, the sponsor, through the application, also can initiate transfers of the contributed tokens from the participants and of the offered tokens from their source, herein called a “vendor” (which may be directly from the sponsor or from another entity the sponsor represents). After the token vault receives tokens from the “vendor,” this is the step taken by a sponsor to confirm that the correct tokens were received and to allow them to be distributed to participants. In response to a sponsor's input to initiate these transfers, the application invokes, respectively, the “TransferToVendor” method and the “ConfirmTokens” method of the deal contract object. The deal contract object in turn causes respective events, herein called “transferred successful” and “tokens confirmed”, which are captured and processed by the event sourcing component to update the database and notify participants.

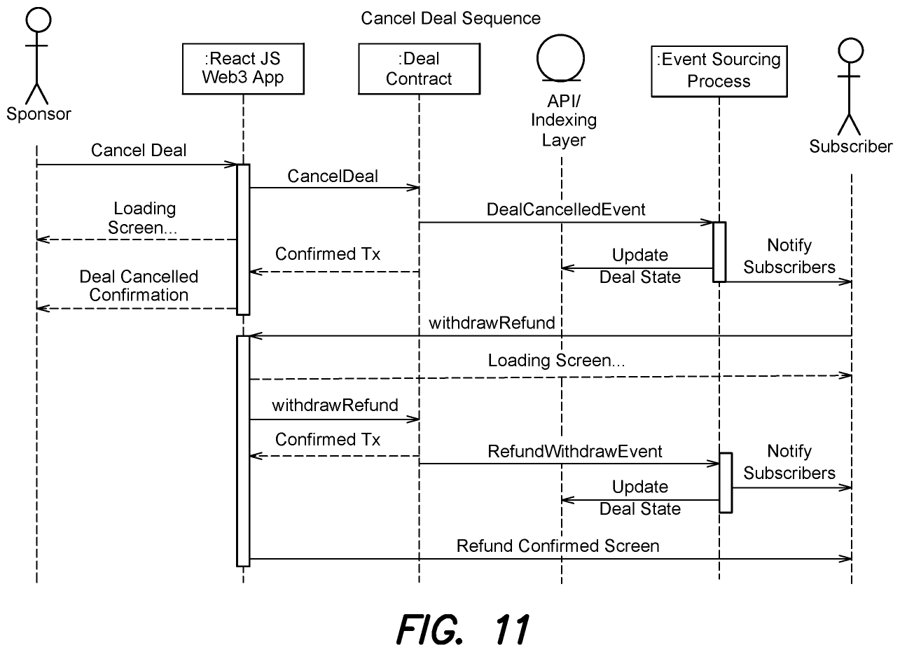

Turning now to FIG. 11, how a deal is cancelled will now be described. A deal can be cancelled by a sponsor. The platform may establish conditions or limits on when the sponsor can cancel a deal. For example, the platform may allow a sponsor to cancel a deal any time before the deal is locked. After a deal is cancelled, if any participants had already contributed funds, the participants will be notified that the funds can be withdrawn.

The process in FIG. 11 starts from a point where the application has presented to a sponsor user, through its graphical user interface, deal information for one of the sponsor's deals. The sponsor can request to cancel a selected deal, by submitting such a request through the application. The application invokes the “CancelDeal” method of the deal contract instance representing the selected deal. The deal contract object responds to the application confirming the status of the transaction, which the application in turn communicates to the sponsor. Cancelling the deal causes the system to generate a “cancel deal” event, which the event sourcing component captures and processes. The deal state is updated in the database, and participants to the deal can be notified.

After a deal is cancelled, a participant can access the system to request to withdraw its funds from the deal through the participant's application. The application may present to a participant user, through its graphical user interface, deal information for one of a selected deal. The participant can request to withdraw the funds from the selected deal. In response to such a request, the application invokes a “WithdrawRefund” method of the deal contract instance representing the selected deal. The deal contract instance confirms the transaction to the application, which in turn communicates the success of the transaction to the participant. The withdrawal causes a “refund withdrawn” event to be generated by the system, which is captured and processed by the event sourcing component to update the database and send notifications.

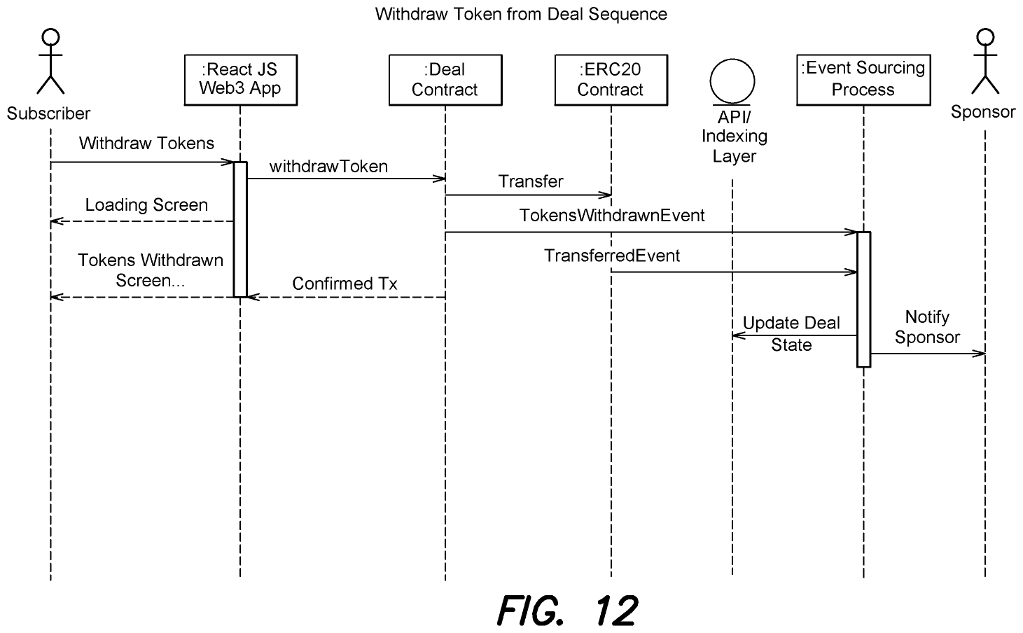

Turning now to FIG. 12, how the system processes requests to withdraw funds related to a deal will now be described.

The process in FIG. 12 starts from a point where the application has presented to a participant user, through its graphical user interface, deal information for one of the deals in which the participant contributed. The participant can request to withdraw its funds from a selected deal, by submitting such a request through the application. The application invokes the “WithdrawToken” method of the deal contract instance representing the selected deal. The deal contract object confirms whether the withdrawal is successful to the application, which in turn communicates the status of the transaction to the participant. The system generates a “TokensWithdrawn” event.

In this implementation, based on deals using ERC20, invocation of the “WithdrawToken” method on the deal contract object causes the deal contract object to invoke the transfer method of an ERC20 token, which effects a transfer and generates a “transferred” event in the system. The event sourcing component captures and processes the “tokens withdrawn” event and the “transferred” event to update the deal state in the database and send notifications to the sponsor that this participant has withdrawn its tokens.

An example specification for an implementation of a transfer method for a TokenVault object is the following:
Inputs (data description/type):

ERC20ContractAddress/address

“TO”/address

tokenAmount/uint256
Type: Public
Input Validations:

ERC20ContractAddress is valid addresses (!=0x0)

to is valid addresses (!=0x0)

ERC20Contract(this). Balance>=tokenAmount
Modifiers: onlyOwner
Outputs: bool true if success
Events:

Name: TokensWithdrawnFromVault

Data (included in the event):

ERC20ContractAddress (indexed)

msg.sender (Deal Contract)

“TO” addresses

tokenAmount

The transfer method first checks validations with it's the deal contract object designated as its owner, then transfers tokens to the “TO” address specified in the inputs, then dispatches the “TokensWithdrawnFromVault” event.

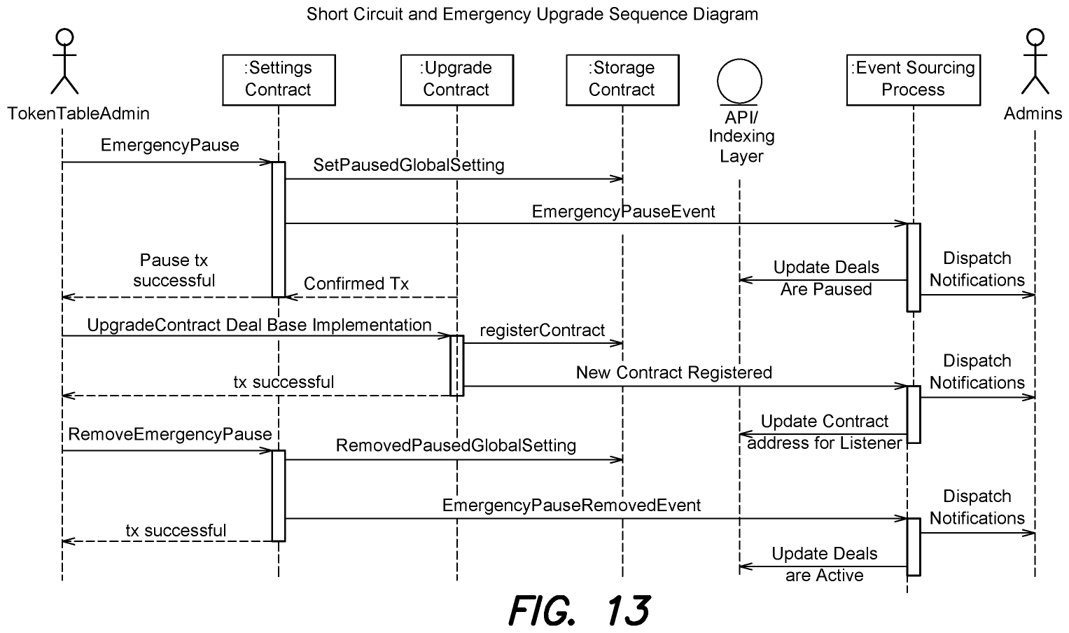

Turning now to FIG. 13, how a deal can be subjected to an emergency pause, for updating, cancelling, or other emergency purpose, will now be described. In this process, the user initiating the activity is an administrator user of the computer system. An emergency pause can be global, for all contracts managed by the system, or local to a specific selected contract.

Through an administrator interface, the administrator causes the application to invoke an EmergencyPause method of a Settings Contract object, which pauses the Deal Factory and all Deal Contracts instances. The setting contract object can also accept a single contract address as a parameter of this method to be paused, such as pausing a specific Deal Contract object instead of a global pause. For a global pause, the settings contract object invokes the “set paused global setting” method of the storage contract object, and generates an “emergency pause” event. The setting contract object communicates to the administrator's application that the pause transaction is successful, which in turn is communicated to the administrator. The event sourcing component captures and process the emergency pause event to update the database and notify other users.

After the pause has been effected, the administrator can upgrade the base implementation of the deal contract object or the base contract object, by deploying the new implementation. Enabling such an upgrade to occur allows bugs, errors, and security issues to be addressed. An “upgrade contract” method of the new deal contract object can be invoked to register the new deal contract base implementation, by updating its implementation address in the Storage Contract object. A “new contract registered” event is then released. The event sourcing component updates the contract address for the listener for the contract to the new implementation address, and dispatches any notifications to other users.

After the upgrade is completed, through an administrator interface the administrator can cause the application to invoke a RemoveEmergencyPause method of the Settings Contract object. The Settings Contract then invokes the RemovedPausedGlobalSetting method of the Storage Contract object. This enables functionality of deal factory object and the deal contract objects. An “emergency pause removed” event is generated, which is captured and processed by the event sourcing module to update the deal state in the database to indicate the updated deals are active, and to dispatch notifications to other users.

Referring again to FIG. 7, more detail about the CreateDeal method of the deal factory object, in an example implementation, will now be provided. The inputs provided through the application, which can be provided by the sponsor, for example, can include the following (indicated by a brief description and data type):
a. Deal Name/String
b. Description/String
c. Token Erc20 Address (Optional)
d. lockTokenAddress/bool (false by default)
e. lockDestinationAddress/bool (false by default)
f. Destination Ethereum Address (Optional address of vendor of the tokens)
g. Sponsors Ethereum Addresses (manager)
h. SponsorCommission in %/uint8 (e.g 2%)
i. Soft Cap/uint256
j. Hard Cap/uint256
k. MinimumPerContributor/uint256
l. MaximumPerContributor/uint256
m. NumberOfDistributions/uint8 (Optional defaults to 1/and max is 255)

The value for Soft Cap should be less than the value for Hard cap. The value for MinimumPerContributor should be less than the value for MaxPerContributor. The value for MinimumPerContributor should be higher than zero; the value for MaximumPerContributor should be higher than zero.

The output of the method is an address for the instance of the deal contract object that is created, with the values set as provided in the inputs. The method invokes the constructor method (described below) of the deal contract object class to create a deal contract instance, which returns an address of the created instance. The deal contract instance also invokes the constructor method of the token vault object class to create a token vault object associated with the newly created deal contract instance, which returns the address of the instance of the token vault object.

The inputs to the constructor method of the deal contract object class to be provided by the deal factory object are the following:
a. Deal Name/String
b. Description/String
c. Token Erc20 Address (Optional can be set later)
d. lockTokenAddress/bool (provided only with token address in constructor and
set to either false or true, if true the sponsor cannot change the address after
construction of deal)
e. lockDestinationAddress/bool
f. false by default same as lockTokenAddress)
g. Destination Ethereum Address (optional)
h. Sponsors Ethereum Addresses
i. SponsorCommission in %/uint8
j. PlatformFee in %/uint8 (taken from settings in storage)
k. Soft Cap/uint256
l. Hard Cap/uint256
m. MinimumPerContributor/uint256
n. MaximumPerContributor/uint256
o. NumberOfDistributions/uint8 (defaults to 1 if zero)

This method dispatches a “deal created” event after a deal contract instance has been successfully created with the corresponding deal information. The data representing the “deal created” event includes details used in indexing the new contract instance and for looking up the contract from the database. In this example implementation, the following data is part of the event:
a. Created Deal Contract address (indexed)
b. Sponsor address (indexed)
c. Deal Name
d. Deal Description

Having now described the system architecture, the graphical user interfaces for the client-side implementation of the system, enabling sponsors and participants to efficiently use such a system to create, manage and participate in deals supported by smart contracts, will now be described in connection with FIGS. 26 through 35. Turning now to FIG. 26, an example implementation of a graphical user interface allowing a sponsor to create a new deal on the platform will be described.

In FIG. 26, this example graphical user interface includes several fields through which a sponsor can provide information which the system will use to create a deal. The sponsor can enter a deal name and description of the deal as text fields. The sponsor can specify parameters related to the sponsor's participation in the deal. A destination address can be specified, which is the destination to which funds raised from participants will be sent. This destination address can be specified later, after the deal is created. If the sponsor is active as a broker, then a sponsor's address can be specified. The sponsor's address is for signing blockchain/deal smart contract actions and receiving commissions if the sponsor chooses to have them sent to this address. Another address, generated by creating the deal, is the token vault address, to which participants will send their contributions and to which the vendor will send tokens. Other parameters of the deal, such as any caps (a soft cap at which the deal is locked and any hard cap) also are specified. The sponsor can specify parameters related to participants, such as a minimum and maximum contribution per participant, a number of distributions, and the kind of authorization required. A sponsor can select whether potential participants can include anyone registered with platform, or only a select list of pre-approved individuals, by selecting an open or private whitelist. A list of excluded countries also can be specified.

In FIG. 26, in response to a user gesture with respect to the “Set Token” button, additional fields can be displayed for entering information about the token that will be the subject of the deal smart contract and that will be distributed to contributors to the deal. The sponsor can enter the address on the blockchain for this the token. Other data about this token can be retrieved from the blockchain platform given this address. Such attributes also could be displayed in the user interface. Creating the deal smart contract through this interface results in the creation of the deal smart contract on the blockchain platform, and storage of information about the created deal in the database on the host server computer.

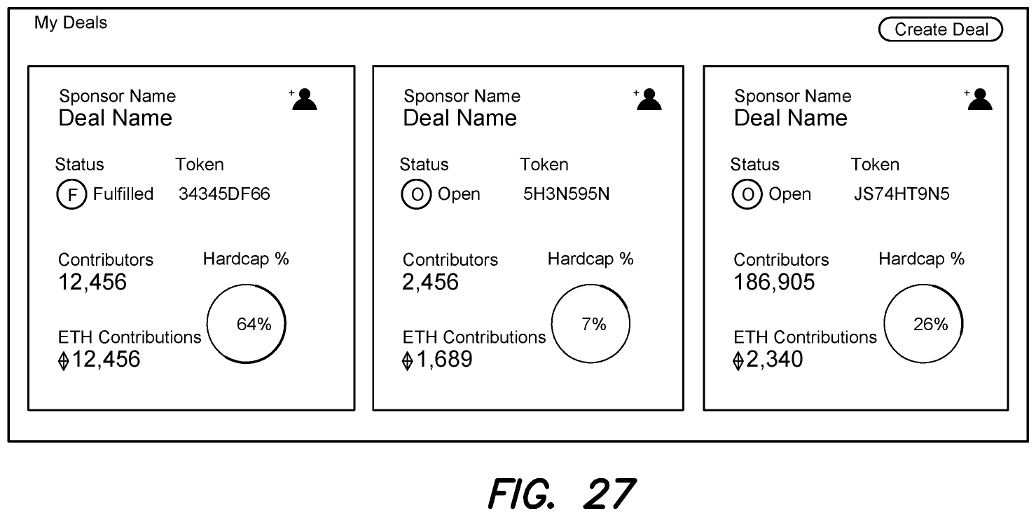

After a sponsor has offered a deal, the sponsor can access a graphical user interface that presents current status of any deals offered by that sponsor. For example, FIG. 27 illustrates an example implementation wherein each deal is represented by a “card” in a “dashboard”, where the card shows the deal name, the sponsor name, a token that is the subject of the deal, a total number of participants, a total amount contributed, a percentage of the hard cap that the total contributions represent, and a state of the deal. The dashboard can include a graphical element such as “button” to create a deal, causing the interface of FIG. 26 to be presented. The user interface can be implemented such that a user gesture with respect to a displayed card for a deal, such as a “button” labeled “deal details”, causes further interfaces showing more details of a selected deal to be presented. This information is obtained from the database 120 (FIG. 1), by accessing data structures such as shown in FIGS. 14-25.

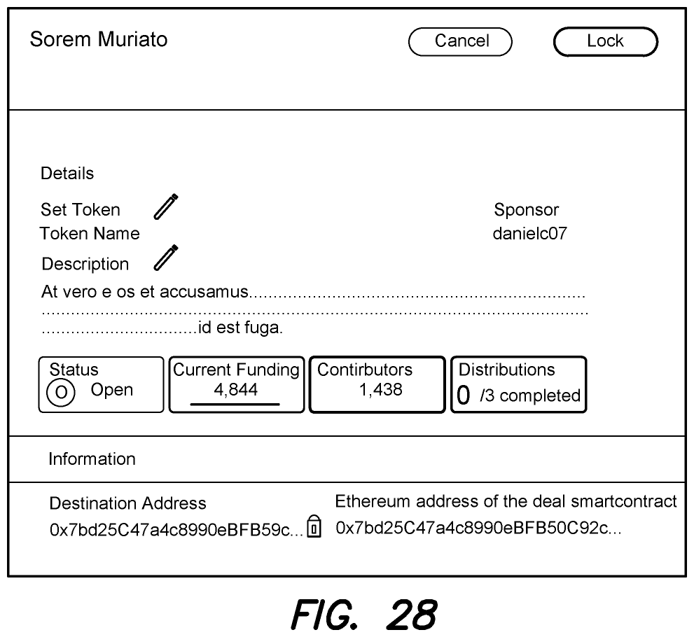

FIG. 28-35 illustrate example graphical elements to convey deal details for a selected deal. For example, some graphical elements (FIG. 28) can provide for information about the deal status and a description of the deal. Status information can include the deal state, the number of participants, the current value in tokens, and any distributions made. As an example, an Ethereum address for distribution of tokens to the sponsor or vendor if the sponsor is a broker, and Ethereum address for the deal smart contract can be presented. A text description, user identifier of the sponsor, and information about the token that is subject of the deal can be provided. A user interface can be provided to allow editing of such data in response to a user gesture with respect to the displayed data. Other information can include details about any sponsor's commission, and any platform fee.

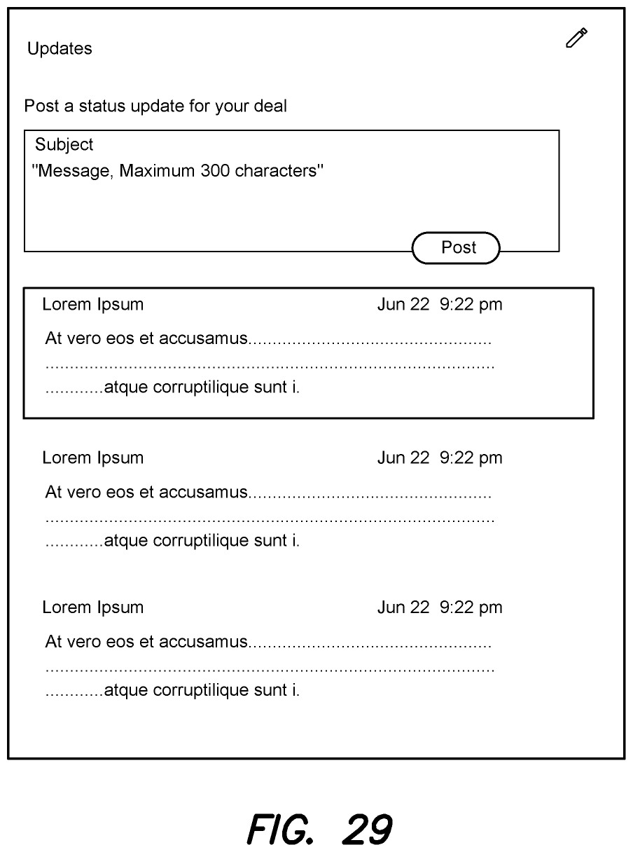

Another graphical element (FIG. 29) can present a list of all of the updates and messages related to the deal smart contract, including a way for the sponsor to send an update to all participants by entering a subject and message in the interface. A button can be provided to signal the platform to send the update message to all participants in the deal. A message can be generated by the platform in response to an event on the platform, or can be generated by the sponsor through this interface.

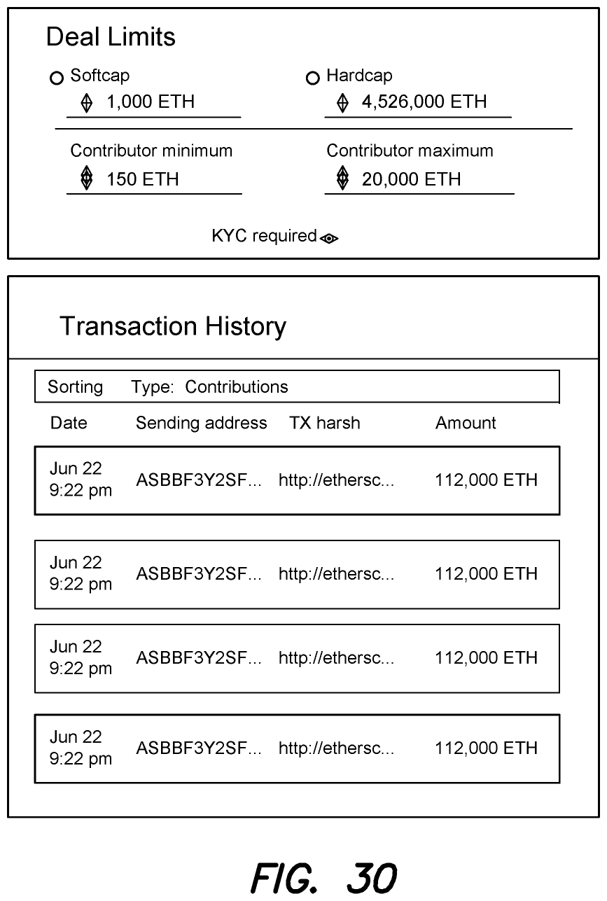

Yet other graphical elements (FIG. 30) can provide information about the deal limits, such as a hard and soft caps, minimum and maximum contribution amounts, and an indication of any know-your-customer (KYC) or authentication requirements, which includes information set by the sponsor in the creation interface (FIG. 26). Another graphical element can present a transaction history (FIG. 30) for the deal smart contract. Each transaction can include data representing the transaction, such as a date, sending address, a hash value representing the transaction, and an amount. Different types of transactions, e.g., contributions and withdrawals, can be presented in separate views which can be selected. Sorting can be made available on any of the displayed fields.

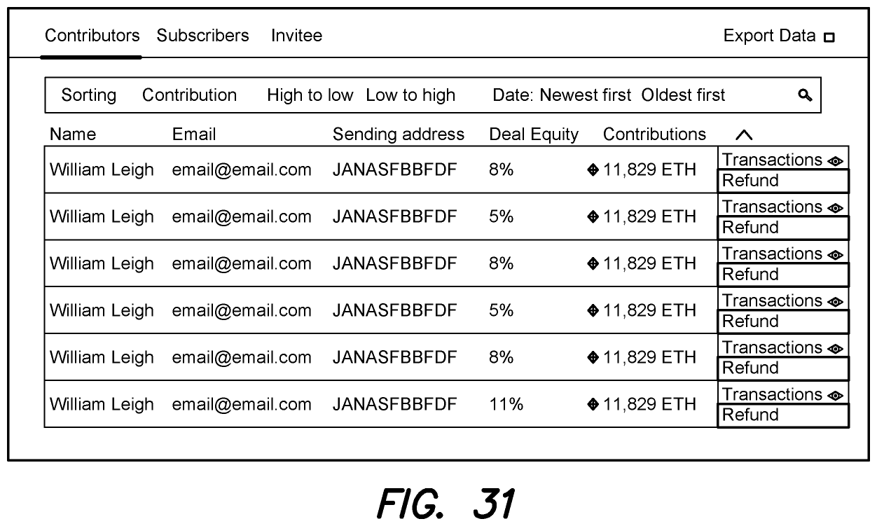

Yet another graphical elements (FIG. 31) can be used to convey detailed information about each participant's interaction with a deal. Information such as an email address, username, contribution amount, Ethereum address for that user, their percent participation in the deal, and reference to view their transactions, can be presented. User interface elements can be provided to allow a sponsor or participant to initiate transactions with respect to the deal, such as withdrawing or refunding tokens.

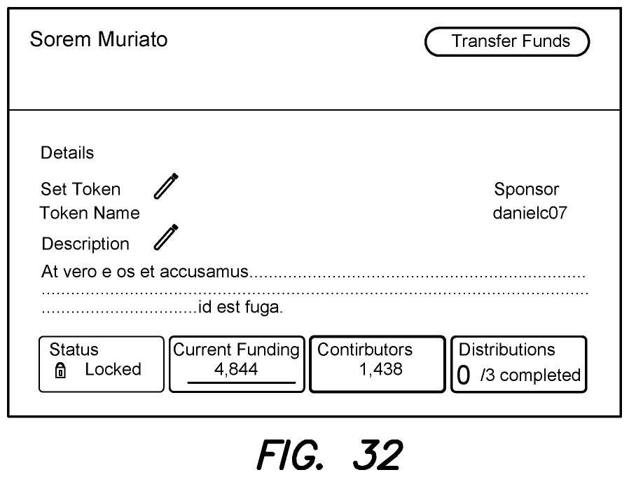

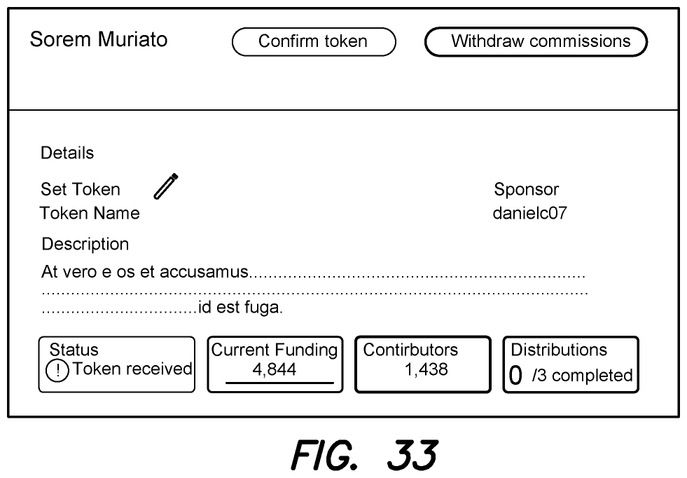

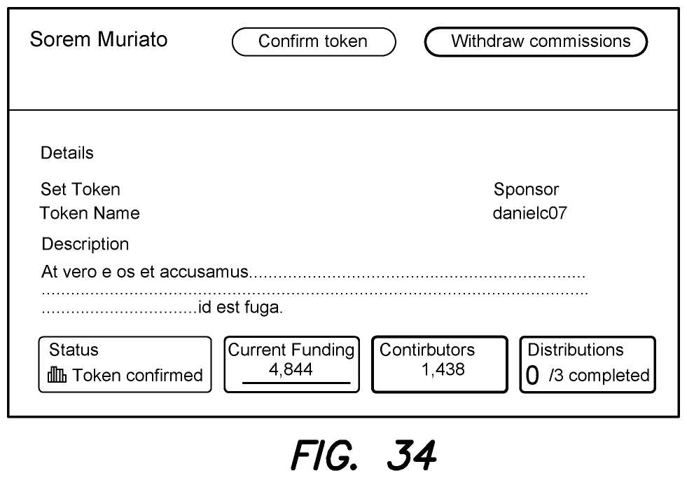

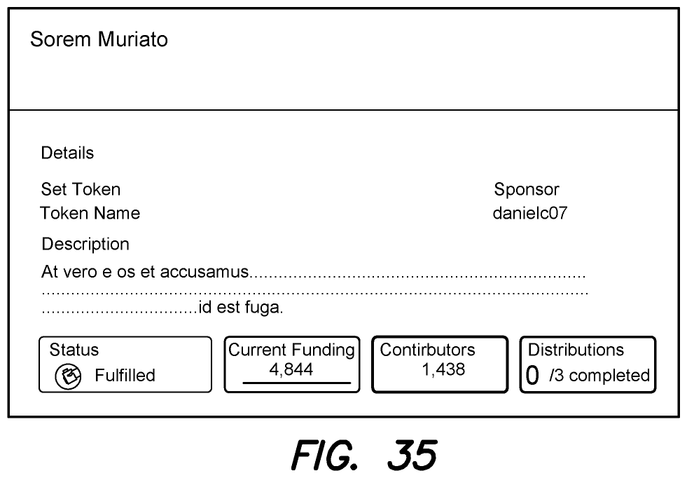

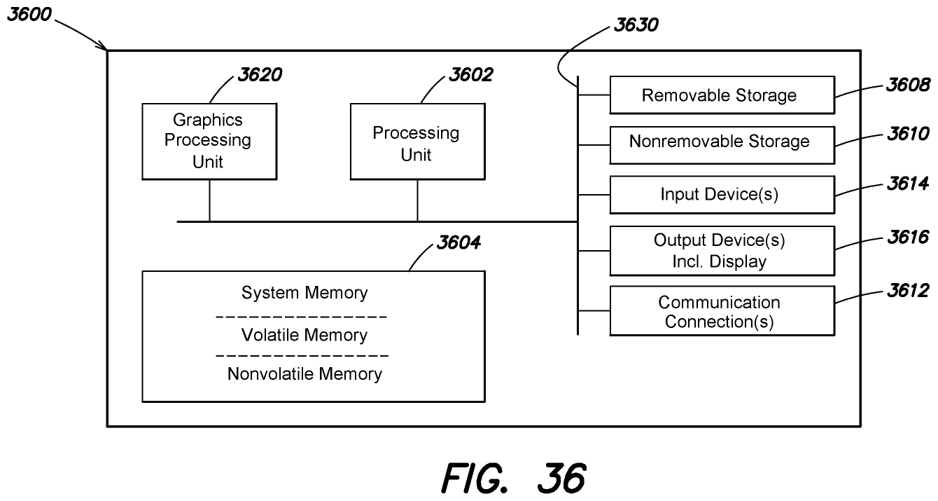

As the state of the deal changes, the available operations through the user interface also can change. For example, while a deal is open, the user interface in FIG. 28 enables a sponsor to each cancel or lock the deal. If a deal is locked, as shown in FIG. 32, the available operation for the sponsor in this implementation is to transfer funds contributed by the participants to the provider of the tokens that are the subject of the deal smart contract (whether the sponsor or another entity for whom the sponsor is a broker). After this transfer, the token that is the subject of the deal smart contract is received, and the deal state changes indicating that the token that is the subject of the deal smart contract has been received. Then, the token that is subject of the deal smart contract can be confirmed, before it is available for distribution to or withdrawal by the participants. See FIG. 33. The sponsor, if a broker, also can withdraw any commission. After the token is confirmed, the deal can change state and the interface can be updated (see FIG. 34). After the tokens are confirmed and the sponsor has withdrawn any commission, the deal smart contract can be indicated as “fulfilled” (FIG. 35) and no further actions are available for that deal smart contract.

Any actions taken by the sponsor to change the state of the deal, or by the contributor to make a contribution or withdrawal, can involve additional dialog boxes or other user interface devices to perform authentication and verification operations. For example, a user may need to confirm its identity to the blockchain or confirm that an operation is intended to be performed if the result of that operation is a permanent change to the state of the deal smart contract, or to an object on the blockchain.

Additional, similar user interfaces can be provided based on different roles, such as for an administrator or contributor, to convey information about deals and perform operations related to deal smart contracts. For example, a contributor interface may provide a way for a user to initiate operations for making contributions, withdrawing contributions and withdrawing tokens. As another example, an administrator interface may provide a way for a user to initiate operations for pausing, cancelling, locking and updating deals.

In some implementations, the tokens received by a contributor are withdrawn by the contributor and not transferred to the contributor automatically. Such an implementation reduces security risks and provides more certainty about the likely processing costs for the transactions. Security risks are reduced because each call is isolated into its own transaction that can be initiated by the recipient of the call. The use of the TokenVault as a single pool of tokens for distribution of tokens, by withdrawal, further allows the calls to be isolated to a single object.

To facilitate any and all access to, and the manipulation of the deal smart contract infrastructure, the platform may integrate with any number of blockchain “wallets,” which may be native to hardware, software or manual applications. Every platform action that requires blockchain access is signed from a user's unique, cryptographic signing address—typically an address paired to a “wallet.” The use of a user's cryptographic private key to validate this address ensures that the correct user is performing an action. While some users may prefer the increased security that comes with issuing manual transactions with a hardware “cold” wallet, the implementation of the platform described herein will be best optimized for use with a Web3 wallet—such as MetaMask—so that as many actions as possible may take place within the user experience of the deal smart contract application. This is an improvement over accessing smart contracts via command line interface or by sending manual transactions through external wallet systems. As used herein, a “wallet” means some combination of a unique address within a blockchain, a cryptographic private key to validate ownership of this address, and some hardware and/or software used to facilitate signing actions therein.

An implementation may include integration with a service or computer system that allows users to transfer funds from fiat currencies like the U.S. Dollar into the platform, which may then facilitate the conversion of said funds into digital equivalents or other digital or cryptographic assets, such as digital coins.

An implementation may include a system, process or mechanism for converting assets or funds held in escrow into tokenized assets or currencies used primarily for their stable valuations (sometimes called “stablecoins”), as an intermediary step during a deal, contract or transaction.

Any of the foregoing aspects may be embodied as a computer system, as any individual component of such a computer system, as a process performed by such a computer system or any individual component of such a computer system, or as an article of manufacture including computer storage in which computer program instructions are stored and which, when processed by one or more computers, configure the one or more computers to provide such a computer system or any individual component of such a computer system.

Having now described an example implementation, FIG. 36 illustrates an example of a computer with which components of the computer system of the foregoing description, such as in FIGS. 1-35, can be implemented. This is only one example of a computer and is not intended to suggest any limitation as to the scope of use or functionality of such a computer.

The computer can be any of a variety of general purpose or special purpose computing hardware configurations. Some examples of types of computers that can be used include, but are not limited to, personal computers, game consoles, set top boxes, hand-held or laptop devices (for example, media players, notebook computers, tablet computers, cellular phones including but not limited to “smart” phones, personal data assistants, voice recorders), server computers, multiprocessor systems, microprocessor-based systems, programmable consumer electronics, networked personal computers, minicomputers, mainframe computers, and distributed computing environments that include any of the above types of computers or devices, and the like.

With reference to FIG. 36, a computer 3600 includes a processing system comprising at least one processing device 3602 and at least one memory 3604. The processing device 3602 can include multiple processing devices; the memory 3604 can include multiple memory devices. A processing device 3602 comprises a processor which is logic circuitry which responds to and processes instructions to provide the functions of the computer. A processing device can include one or more processing cores (not shown) that are multiple processors within the same logic circuitry that can operate independently of each other. Generally, one of the processing devices in the computer is designated as a primary processor, typically called the central processing unit (CPU). One or more additional co-processing units, such as a graphics processing unit (GPU) 3620, also can be present in the computer. A co-processing unit comprises a processor that performs operations that supplement the central processing unit, such as but not limited to graphics operations and signal processing operations.

The memory 3604 may include volatile computer storage devices (such as dynamic random-access memory (DRAM) or other random-access memory device), and non-volatile computer storage devices (such as a read-only memory, flash memory, and the like) or some combination of the two. A nonvolatile computer storage device is a computer storage device whose contents are not lost when power is removed. Other computer storage devices, such as dedicated memory or registers, also can be present in the one or more processors. The computer 3600 can include additional computer storage devices (whether removable or non-removable) such as, but not limited to, magnetically-recorded or optically-recorded disks or tape. Such additional computer storage devices are illustrated in FIG. 1 by removable storage device 3608 and non-removable storage device 3610. Such computer storage devices 3608 and 3610 typically are nonvolatile storage devices. The various components in FIG. 36 are generally interconnected by an interconnection mechanism, such as one or more buses 3630.

A computer storage device is any device in which data can be stored in and retrieved from addressable physical storage locations by the computer by changing state of the device at the addressable physical storage location. A computer storage device thus can be a volatile or nonvolatile memory, or a removable or non-removable storage device. Memory 3604, removable storage 3608 and non-removable storage 3610 are all examples of computer storage devices. Some examples of computer storage devices are RAM, ROM, EEPROM, flash memory or other memory technology, CD-ROM, digital versatile disks (DVD) or other optically or magneto-optically recorded storage device, magnetic cassettes, magnetic tape, magnetic disk storage or other magnetic storage devices. Computer storage devices and communication media are distinct categories, and both are distinct from signals propagating over communication media.

Computer 3600 may also include communications connection(s) 3612 that allow the computer to communicate with other devices over a communication medium. Communication media typically transmit computer program instructions, data structures, program modules or other data over a wired or wireless substance by propagating a modulated data signal such as a carrier wave or other transport mechanism over the substance. The term “modulated data signal” means a signal that has one or more of its characteristics set or changed in such a manner as to encode information in the signal. By way of example, and not limitation, communication media includes wired media, such as metal or other electrically conductive wire that propagates electrical signals or optical fibers that propagate optical signals, and wireless media, such as any non-wired communication media that allows propagation of signals, such as acoustic, electromagnetic, electrical, optical, infrared, radio frequency and other signals.

Communications connections 3612 are devices, such as a wired network interface, wireless network interface, radio frequency transceiver, and network interface devices, or other device, that interface with communication media to transmit data over and receive data from signal propagated over the communication media.

The computer 3600 may have various input device(s) 3614 such as a pointer device, keyboard, touch-based input device, pen, camera, microphone, and sensor. The computer 3600 may have various output device(s) 3616 such as a display, speakers, and so on. Such devices are well known in the art and need not be discussed at length here. Various input and output devices can implement a user interface, which can be, but is not necessarily, graphical.

The various computer storage devices 3608 and 3610, communication connections 3612, output devices 3616 and input devices 3614 can be integrated within a housing with the rest of the computer, or can be connected through various input/output interface devices on the computer in which case the reference numbers 3608, 3610, 3612, 3614 and 3616 can indicate either the interface for connection to a device or the device itself.

A computer generally includes an operating system, which is a computer program that, when executed, manages access, by other applications running on the computer, to the various resources of the computer. There may be multiple applications. The various resources include the processing devices, coprocessing units, memory, storage, input devices and output devices, such as display devices and input devices as shown in FIG. 36. To manage access to data stored in nonvolatile computer storage devices, the computer also generally includes a file system which maintains files of data. A file is a named logical construct which is defined and implemented by the file system to map a name and a sequence of logical records of data to the addressable physical locations on the computer storage device. A file system generally provides operations such as creating a file, opening a file, writing a file or its attributes, reading a file or its attributes, and closing a file.

The various modules, tools, or applications, and data structures and flowcharts, and graphical user interfaces, described in connection with FIGS. 1-35, as well as any operating system, file system and applications on a computer in FIG. 36, can be implemented using one or more processing devices of one or more computers with one or more computer programs processed by the one or more processing devices.

A computer program includes computer-executable instructions and/or computer-interpreted instructions, such as program modules, which instructions are processed by one or more processing devices or co-processing units in the computer. Generally, such instructions define routines, programs, objects, components, data structures, and so on, that, when processed by a processing device, instruct or configure the computer to perform operations on data, or configure the computer to implement various components, modules or data structures.

A computer program includes computer-executable instructions and/or computer-interpreted instructions, such as program modules, which instructions are processed by one or more processing units in the computer. Generally, such instructions define routines, programs, objects, components, data structures, and so on, that, when processed by a processing unit, instruct or configure the computer to perform operations on data, or configure the computer to implement various components, modules or data structures. Such components and modules have inputs and outputs through locations in memory or processor registers from which data in such data structures can be read and to which data in such data structures can be written when the component or module is executed by the computer.

The subject matter defined in the appended claims is not necessarily limited to the specific implementations described above. The specific implementations described above are disclosed as examples only.

### APPENDIX I

### Method: RegisterAddress

Description: This method allows participants to register an address on a deal to be able to contribute by adding the address to a whitelist if the validation process succeeds. This method uses an Oracle to check the TokenTable API. The participant should send enough gas in the transaction to call this method and cover the Oracle costs.

### Type: Public Payable

Modifiers: isNotPaused

### Inputs:

uuid generated by api/bytes32

### Input Validations

Contract state==OPEN or (state==LOCKED and now(block.number)<LockTime)
msg.value>SPECIFIED_GAS_FOR_ORACLE
   (can be set on Storage as global variable)

### Outputs

Return boolean true if method was successful

### Events

### Name: AddressRegisteredReceived

### Data:

address of contributors (msg.sender)
uuid used/bytes32

### Steps:

Contract checks validations
Contract gets configured API url in storage.
Contract calls Oracle passing the following arguments:
API url to validate uuid
msg.sender (participant address)
uuid/token to allow access
   Contract ends use case waiting for Oracle callback.
   Steps for Oracle Callback: (this step happens on a different transaction)
   Oracle returns a callback result from API
   Contract checks result for participant address==TRUE

alt.path
if result==FALSE
use case ends
   Contract adds address to whitelist mapping==TRUE
   Use case ends

### Method: Contribute

Description: This method allows participants to join a deal by sending ETH to the contract.

### Type: Public Payable

Modifiers: isNotPaused

### Inputs:

None—by default a payable method should have access to the msg.value and msg.sender to track the address of the participant and the contribution amount.

### Input Validations

Msg.value>=minContribution
Msg.value<=maxContribution
Contract state==OPEN or (state==LOCKED and now(block.number)<LockTime)
GetContributedBalance( )<hardCap

### Outputs

Return boolean true if method was successful

### Events

### Name: ContributionReceived

### Data:

address of contributors (msg.sender)
amount contributed (msg.value)

### Steps:

Contract checks validation for msg.value and msg.sender
Contract checks msg.sender address is in whitelist mapping==TRUE

alt.path
if msg.sender address is not in whitelist mapping then transaction fails
end use case
   If user has contributed before to this Deal

Get the amount contributed from mapping

Update mapping to track amount of total contribution of address (address→uint)

### Dispatch ContributionReceived Event

End use case with true value.

### Method: Cancel

Description: This method allows a sponsor to cancel a deal.

### Type: Public

Modifiers: isOpen onlySponsor isNotPaused

### Inputs:

None (by default we use the msg.sender to validate access)

### Input Validations

Contract needs to be in Open state and msg.sender==sponsor

### Outputs

Return boolean true if method was successful

### Events

### Name: ContractCancelled

### Data:

address of sponsor (msg.sender)

### Steps:

Contract checks validation
Update contract state to CANCELLED
End use case

### Method: CancelLockedDeal

Description: This method allows a TokenTable admin to cancel a deal. This is a fail safe method only to be used when a Deal has been Locked and it has been 24 hours after the Deal has been Locked without transferring the funds.

### Type: Public

Modifiers: isLocked onlyAdmin (superUser)

### Inputs

None (by default we use the msg.sender to validate access)

### Input Validations

Contract needs to be in Locked state and msg.sender==tokenTableAdminAccount.

Contract needs to be Locked for 24 hours without the balance being transferred.

### Outputs

Return boolean true if method was successful

### Events

### Name: LockedContractCancelled

### Data:

address of admin (msg.sender)

### Steps:

Contract checks validations
Update contract state to CANCELLED
End use case

### Method: WithdrawContribution

Description: This method allows a participant to withdraw his contribution. The participant will withdraw the complete amount.

### Type: Public

Modifiers: isOpenOrCancelled isNotPaused

### Inputs:

None (by default we use the msg.sender to validate access)

### Input Validations

Msg.sender is part of the contributors mapping and has a non zero contribution state==OPEN or state==CANCELLED (modifier isOpenOrCancelled)

### Outputs

Return boolean true if method was successful

### Events

### Name: ContributionRefunded

### Data:

address of contributors (msg.sender)
amount refunded

### Steps:

Contract checks validation for msg.sender
If user has contributed before to this Deal

Alt. Step If user has NOT contributed before to this Deal
fail transaction
end use case
   Update mapping of total contribution of address to zero balance (address→uint)
   Transfer contribution amount to msg.sender

### Dispatch ContributionRefunded

End use case

### Method: Lock

Description: This method allows a sponsor to lock a deal.

### Type: Public

Modifiers: isOpen onlySponsor isNotPaused

### Inputs:

timeBeforeLocked/uint256 (time in hours/default to 24 hours on UI)

### Input Validations

Msg.sender==sponsor
total contributed balance (calculated using GetContributedBalance method)>=soft cap and<=hard cap

### Outputs

Return boolean true if method was successful

### Events

### Name: DealLocked

### Data:

address of sponsor
LockTime (calculated from current time+timeBeforeLock)

### Steps:

Contract checks validations
Contract updates contract state to Locked
Contract updates LockTime field calculating now+timeBeforeLock (default is 1 day)

### Dispatch DealLocked Event

End use case

### Method: TransferFundsToDestination

Description: This method allows a sponsor to transfer the funds to the destination address.

### Type: Public

Modifiers: isLocked onlySponsor isNotPaused

### Inputs:

None (by default we use the msg.sender to validate access)

### Input Validations

Msg.sender==sponsor

state==Locked

DestinationAddress !=0x0

Now>=LockTime

### Outputs

Return boolean true if method was successful

### Events

### Name: FundsTransferred

### Data:

address of sponsor (msg.sender)
destination address
transferred amount

### Steps:

Contract checks validations
Calculate sponsorCommissionAmount from feePercentage and current contract balance.
Calculate platformFeeAmount from platformFeePercentage and current contract balance.
Calculate total funds to transfer from Contract balance minus sponsorCommissionAmount and minus platformFeeAmount.
(e.g TotalFundsToTransfer=contractBalance−(platform+sponsor commission amount)
Update sponsorCommissionAmount from calculation.
Update platformFeeAmount from calculation.
Update state variable totalFundsToTransfer
Update contract state to FundsSent
Send calculated total funds to destination address

### Dispatch FundsTransferred

End use case

### Method: ConfirmTokens

Description: This method allows a sponsor to confirm the tokens are available in the contract to be withdrawn by participants, I can be call several times depending on number of distributions.
Note: Creates one instance of a TokenVault contract to transfer the tokens to for all distributions.

### Type: Public

Modifiers: onlySponsor isNotPaused

### Inputs:

None (by default we use the msg.sender to validate access)

### Input Validations

Msg.sender==sponsor
state==FUNDS_SENT
tokenAddress !=0x0
check numberOfDistributions>availableDistributions (availableDistributions starts in 0 on Contract Construction)
check ERC20 Balance for Deal Address is>0

### Outputs

Return boolean true if method was successful

### Events

### Name: TokensConfirmed

### Data:

address of sponsor (msg.sender)
tokenVaultAddress
numberOfConfirmedDistribution
tokenBalance

### Steps:

Contract checks validation
Update availableDistributions=availableDistributions+1
If TokenVault not created then Create New TokenVault instance address and saves it in the Contract field
Update distribution data in struct and append to Distribution Struct Array.
Transfer Deal Total Balance of ERC20 contract to TokenVault address
if availableDistributions==numberOfDistributions then Update contract state to CLOSED
Dispatch TokensConfirmed event
End use case

### Note:

We need a Struct array to keep track of distribution data
struct distribution={

number: uint8

amountOfTokens: uint256

available: bool

}

### Method: GetParticipantTokenBalance

Description: This method allows a participant to query his token balance.
We keep use the distribution array Struct to query the data needed to calculate the correct token balance.

### Type: View

### Modifiers:

### Inputs:

None. Uses msg.sender

### Input Validations

msg.sender is part of contributors
state==FUNDS_TRANSFERRED OR state==CLOSED

### Outputs

Return uint256 with Total TokenBalance

### Events

### None

### Steps:

Contract checks validations
if address has withdrawn from all availableDistributions

alt.path
return 0
   Get lastNumberOfDistribution withdrawn from this address (check mapping=>uint8) totalTokenBalance=0
Loop while index=lastNumberOfDistribution<=availableDistribution (increment index) contributorsTokens=proportion %
Distribution StructArray[index].amountOfTokens totalTokenBalance=totalTokenBalance+contributorsTokens assert Balance in ERC20 contract using Vault address should be>totalTokenBalance
   Return totalTokenBalance
   End use case
Note: Proportion % is based on field totalFundsToTransfer and msg.sender contribution percentage calculation.

Precision and safe math should be taken into account in token value calculations

### Method: WithdrawTokens

Description: This method allows a participant to withdraw his tokens from a deal. The method withdraws the complete amount of tokens for each particular participant depending on his current TotalToken Balance.
Note: Uses method GetParticipantTokenBalance

### Type: Public

Modifiers: isNotPaused

### Inputs:

None (by default we use the msg.sender to validate access)

### Input Validations

Msg.sender is part of contributors
state==FUNDS_SENT_OR state==CLOSED
call GetParticipantTokenBalance for msg.sender>0

### Outputs

Return boolean true if method was successful

### Events

### Name: TokensWithdrawn

### Data:

address of participant (msg.sender)
amount of tokens withdrawn

### Steps:

Contract checks validations
Get lastNumberOfDistribution withdrawn from this address
(check participantToDistributionMapping address=>uint8)
Update participantToDistributionMapping (address=>uint8) to equal availableDistributions
value to track that participant has withdrawn all current available tokens.
Loop while index=lastNumberOfDistribution<=availableDistribution contributorsTokens=proportion %* DistributionStructArray[index].amountOfTokens
transfer contributorTokens from TokenVault to msg.sender
(TokenVault.transfer(msg.sender, contributorsTokens))
(increment index)
   End use case
   Note: Proportion % is based on field totalFundsToTransfer and msg.sender contribution percentage calculation.
   Precision and safe math should be taken into account in token value calculations

### Method: WithdrawTokensTo

Description: This method allows a participant to withdraw his tokens from a deal. The
method withdraws the complete amount of tokens for each particular participant depending
on his current TotalToken Balance.
Note: Uses method GetParticipantTokenBalance

### Type: Public

Modifiers: isNotPaused

### Inputs:

receivingAddress/address

### Input Validations

Msg.sender is part of contributors
receivingAddress !=0x0
state==FUNDS_SENT_OR state==CLOSED
call GetParticipantTokenBalance for msg.sender>0

### Outputs

Return boolean true if method was successful

### Events

### Name: TokensWithdrawnToAddress

### Data:

address of participant (msg.sender)
Receiving Address
amount of tokens withdrawn

### Steps:

Contract checks validations
Get lastNumberOfDistribution withdrawn from this address
(check participantToDistributionMapping address=>uint8)
Update participantToDistributionMapping (address=>uint8) to equal availableDistributions value to track that participant has withdrawn all current available tokens.
Loop while index=lastNumberOfDistribution<=availableDistribution contributorsTokens=proportion %* DistributionStructArray[index].amountOfTokens
transfer contributorTokens from TokenVault to receivingAddress
(TokenVault.transfer(receivingAddress, contributorsTokens)) (increment index)
   End use case
   Note: Proportion % is based on field totalFundsToTransfer and msg.sender contribution percentage calculation.
   Precision and safe math should be taken into account in token value calculations

### Method: WithdrawSponsorCommission

Description: This method allows a sponsor to cancel a deal.

### Type: Public

Modifiers: onlySponsor isNotPaused

### Inputs:

None (by default we use the msg.sender to validate access)

### Input Validations

Msg.sender==sponsor
sponsorCommissionAmount>0
state==FUNDS_SENT OR state==CLOSED
availableDistributions>0 (means that sponsor has confirmed at least one token distribution)

### Outputs

Return boolean true if method was successful

### Events

### Name: SponsorCommissionWithdrawn

### Data:

address of sponsor (msg.sender)
amount withdrawn

### Steps:

Contract checks validations
We check amount of distributions and divide the sponsor commission into equal parts we check what was the last withdraw commission portion from sponsor (mapping like the contributors)
(e.g amountOfDistributions=3 then we release the commission on each distribution sponsorCommissionAmount=sponsorCommissionAmount/3)
each portion of the commission amount should be available depending on token confirmations.
(e.g if only 2 out of 3 confirmations are available then sponsor can only withdraw ⅔ of totalCommissionAmount)
End use case

### Method: WithdrawPlatformFee

Description: This method allows a platform admin to withdraw the platform commission.

### Type: Public

Modifiers: isFundsSent onlyAdmin isNotPaused

### Inputs:

None (by default we use the msg.sender to validate access)

### Input Validations

Msg.sender==tokenTableAdmin (check from roles in storage)

### Outputs

Return boolean true if method was successful

### Events

### Name: PlatformFeeWithdrawn

### Data:

address of admin (msg.sender)
amount contributed (msg.value)

### Steps:

Contract checks validations
Update platformFeeAmount to zero
Send platformFeeAmount to msg.sender(admin)

### Dispatch PlatformFeeWithdrawn

### Method: SetDestinationAddress

Description: This method allows a sponsor to set the destination address for a deal.

### Type: Public

Modifiers: isOpen onlySponsor isNotPaused

### Inputs:

NewDestinationAddress/address

### Input Validations

Msg.sender==sponsor
NewDestinationAddress !=0x0
lockDestinationAddress==FALSE

### Outputs

Return boolean true if method was successful

### Events

### Name: DestinationAddressUpdated

### Data:

address of sponsor (msg.sender)
Current Destination Address (0x0 if not set)
New Destination Address

### Steps:

Contract checks validations
Update destination address of contract

### Dispatch DestinationAddressUpdated

End use case

### Method: ForceRefund

Description: This method allows a sponsor to force a refund to a specific user.

### Type: Public

Modifiers: isOpen onlySponsor isNotPaused

### Inputs:

refundAddress/address

### Input Validations

Msg.sender==sponsor
refundAddress is part of mapping for contributors(refundAddress balance>0)

### Outputs

Return boolean true if method was successful

### Events

### Name: ForceRefundDone

### Data:

address of contributors (refundAddress)
address of sponsor (msg.sender)
amount refunded (msg.value)

### Steps:

Contract checks validations
Check contributedAmount in contribution mapping for address.
Update mapping of refundAddress to zero balance in contribution mapping.
Send contributedAmount to refundAddress

### Dispatch ForceRefundDone

End use case

### Method: GetContributionBalance

Description: This method gets the calculated balance of contributions minus commission and
fee amount for both sponsor and platform.

### Type: View

### Modifiers:

### Inputs:

None

### Input Validations

None

### Outputs

Return uint256 totalContributionBalance representing the balance in wei of the calculated total balance

### Calculation:

platformFeeAmount=contract.balance*platformCommissionFee %
sponsorCommissionAmount=contract.balance*sponsorCommissionFee %
totalContributionBalance=contract.balance−(platformFeeAmount+sponsorCommissionAmount)
return totalContributionBalance

### Events

### None

Note example from Rob:
The idea here is to have the contract calculate the relevant fees in advance and allow for the contract “hard cap” to be met in full while accepting an overage equal to the fees to be paid out from the pool. A simple example would be: Sponsor creates pool with a hard cap of 100ETH for Fu Coin and is charging a 2% fee and Token Table takes 0.5%. So the contract will except 100Eth+2.50=102.50Eth before beginning to reject additional contributions and triggering the “Hard Cap Reached” status.

### Additional Note

The gas cost for transferring the contract balance to the destination address are not taken into account since this amount is payed by the sponsor on the TransferFundsToDestination method.

### Method: GetSponsorCommissionAmount

Description: This method gets the sponsor's commission amount calculated with the current
contract's balance

### Type: View

### Modifiers:

### Inputs:

None

### Input Validations

None

### Outputs

Return uint256 sponsorCommissionAmount representing the commission amount in wei.

### Calculation:

sponsorCommissionAmount=contract.balance*sponsorCommissionFee %
return sponsorCommissionAmount

### Events

### None

### Method: GetPlatformFeeAmount

Description: This method gets the platform's fee amount calculated with the current contract's balance

### Type: View

### Modifiers:

### Inputs:

None

### Input Validations

None

### Outputs

Return uint256 platformFeeAmount representing the fee amount in wei.

### Calculation:

platformFeeAmount=contract.balance*platformCommissionFee %
return platformFeeAmount

### Events

### None

### Method: SetHardCapAddress

Description: This method allows a sponsor to change the hard cap value

### Type: Public

Modifiers: isOpen onlySponsor isNotPaused

### Inputs:

newHardCapAmount/uint256

### Input Validations

msg.sender==sponsor
hardCapAmount>softCap

### Outputs

Return boolean true if method was successful

### Events

### Name: HardCapUpdated

### Data:

address of sponsor (msg.sender)
Previous Hard Cap amount
New Hard Cap amount

### Steps:

Contract checks validations
Update Hard Cap Amount with newHardCapAmount

### Dispatch HardCapUpdated Event

End use case

### Method: SetMaximumPerContributor

Description: This method allows a sponsor to change the MaximumPerContributor value.

### Type: Public

Modifiers: isOpen onlySponsor isNotPaused

### Inputs:

NewMaximumPerContributor/uint256

### Input Validations

msg.sender==sponsor
MaximumPerContributor>MinPerContributor

### Outputs

Return boolean true if method was successful

### Events

### Name: MaximumPerContributorUpdated

### Data:

address of sponsor (msg.sender)
Previous Value
New MaximumPerContributor amount

### Steps:

Contract checks validations
Update MaximumPerContributor value NewMaximumPerContributor

### Dispatch MaximumPerContributorUpdated Event

End use case

### Method: SetTokenAddress

Description: This method allows a sponsor to set the token address for a deal.

### Type: Public

Modifiers: onlySponsor isNotPaused

### Inputs:

tokenAddress/address

### Input Validations

Msg.sender==sponsor
lockTokenAddress==FALSE
state !=FUNDS_SENT
state !=CLOSED

### Outputs

Return boolean true if method was successful

### Events

### Name: TokenAddressUpdated

### Data:

address of sponsor (msg.sender)
Token Address

### Steps:

Contract checks validations
if (tokenAddress==0x0) OR (tokenAddress !=0x0 AND now<=lastTokenUpdateTime)

alt.Path if conditions are false
fail
exit use case
   Update lastTokenUpdateTime to now+30 minutes
   Update token address of contract

### Dispatch TokenAddressUpdated Event

End use case

### Modifiers

### IsOpen

Conditions:

state===OPEN

isLocked

Conditions:

state===LOCKED

isOpenOrCancelled

Conditions:

state OPEN or state CANCELLED

isFundsSent

Conditions:

state===FUNDS_SENT

isClose

Conditions:

state===CLOSED

onlySponsor

Conditions:

msg.sender===sponsor

onlyAdmin

Conditions:

hasRole(‘admin’,msg.sender)===true

Note: Example implementation in Base Contract

isNotPaused

Conditions:

checkStorage(“state.paused”)===false

Note: Example implementation in Base Contract

What is claimed is:

1. A computer system, comprising:
a blockchain platform having a distributed application deployed thereon, the distributed application comprising:
a storage contract instance in which data for contracts on the blockchain are stored,
a base contract object class defining an interface enabling base contract instances to communicate with and store data in the storage contract instance,
a deal contract object class defining a data representation of a deal contract including a plurality of states, an indication of a sponsor, an indication of participants, and a reference to authorized potential participants, and associated methods including methods that, when invoked on a deal contract instance, change the state of the deal contract instance, register individuals as authorized potential participants, and accept authorized participants;
an address registry object class defining a data representation of authorized potential participants, and associated methods including methods that, when invoked on an address registry instance, add a participant as an authorized potential participant and verify that an individual is an authorized potential participant;
wherein the method of the deal contract object to accept authorized participants, when invoked for a deal contract instance with an indication of a potential participant, performs the steps of invoking the verification method of the address registry instance associated with the deal contract instance using the indication of the potential participant, and, in response to verification that the potential participant is authorized, adding the potential participant as a participant to the deal contact instance; and
wherein the method of the deal contract object to register an individual, when invoked for a deal contract instance with an indication of an individual, performs the steps of accessing an oracle object to verify identity of the individual, and, in response to verification, invokes the method of the address registry instance associated with the deal contract instance to add the individual as an authorized potential participant of the deal contract instance.

2. The computer system of claim 1 wherein methods to change state of a deal contract instance are invoked by a sponsor.

3. The computer system of claim 1 wherein the distributed application further comprises:
a token vault object class having a data representation indicating a number of tokens from the blockchain platform stored for an individual, wherein a token vault object instances are associated with deal contract instances and store tokens for an individual with respect to the associated deal contract instance.

4. The computer system of claim 1 further comprising a graphical user interface allowing a sponsor to create a deal contract.

5. The computer system of claim 1 further comprising a graphical user interface allowing a participant to participate a deal contract.

6. A computer system, comprising:
a. a blockchain platform having a distributed application deployed thereon, the distributed application comprising:
i. a storage contract instance in which data for deal smart contract objects on the blockchain are stored,
ii. a base contract object class defining an interface enabling base contract instances to communicate with and store data in the storage contract instance,
iii. a deal smart contract object class extending the base contract object class and defining a representation of a deal smart contract including a plurality of states, an indication of a sponsor, an indication of participants, and a reference to authorized potential participants, and associated methods including methods that, when invoked on a deal smart contract instance, change the state of the deal smart contract instance, register individuals as authorized potential participants, and accept authorized participants;
b. a host platform comprising:
i. a database storing data describing instances of deal smart contract objects deployed on the blockchain platform;
ii. an event sourcing component having an input to receive information about events occurring for instances of deal smart contract objects on the blockchain platform, the event sourcing component storing information in the database in response to such events; and
iii. an interface to client computers to provide information from the database about instances of deal smart contract objects to allow actions to be taken through the client computers to invoke the methods of the instances of the deal smart contract objects deployed on the blockchain platform.
